(19) United States
(12) Patent Application Publication
(10) Pub. No.: US 2026/0110139 A1
(43) Pub. Date: Apr. 23, 2026

(54) CROSS-LINKED POLYVINYL ALCOHOL ADHESIVES

(71) Applicant: The Procter & Gamble Company, Cincinnati, OH (US)

(72) Inventors: Cahit EYLEM, West Chester, OH (US); Gregory Thomas APPLEGATE, Cincinnati, OH (US); Mary Katherine HAMILTON, Deerfield Township, OH (US); Stephanie Michelle PROCTOR, Union, KY (US); David Warren LOEBKER, Cincinnati, OH (US); Derrick Eugene TURNER, JR., Middletown, OH (US); Ty Gerald NOE, Loveland, OH (US); VICTOR SHULL, Cincinnati, OH (US)

(21) Appl. No.: 19/364,033

(22) Filed: Oct. 21, 2025

Related U.S. Application Data
(60) Provisional application No. 63/710,172, filed on Oct. 22, 2024.

(51) Int. Cl. D21H 19/12; C09J 5/00; C09J 11/06; C09J 129/04; D21H 27/00; D21H 27/36

(52) U.S. Cl. CPC D21H 19/12; C09J 5/00; C09J 11/06; C09J 129/04; D21H 27/002; D21H 27/36; C09J 2400/286; C09J 2429/00

(57) ABSTRACT

Multi-ply structures incorporating adhesive compositions, products produced from such structures, and methods of producing the structures.

### FIELD OF THE INVENTION

Polyvinyl alcohol (PVOH) cross-linked with alkaline sodium borate to produce adhesives having wet ply bond strength to bind plies of a multi-ply absorbent product.

### BACKGROUND OF THE INVENTION

When producing a multi-ply absorbent product, the plies are frequently joined together using adhesive that will maintain the separate layers or plies when the product is subjected to the forces encountered during use. Frequently tissue paper products, particularly paper toweling, are wetted in use such as wiping spills, cleaning hard soils off the surfaces, cleaning dishes, and mirrors all impart forces upon the structure of the absorbent product which can cause the structure to rupture and tear. If the wet ply bond strength is insufficient, the bonding between plies fails, the plies then move against each other imparting frictional forces at the interface. This eventually causes the plies to separate, and the paper product is destroyed.

Multi-ply tissue products having wet ply bond strength are disclosed in U.S. Pat. No. 9,840,812 B2 and U.S. Pat. No. 5,693,406 which teach using thermosetting resins to modify polyvinyl alcohol (PVOH) ply glue resins. U.S. Pat. No. 10,968,571 B2 discloses multi-ply tissue product having water resistant thermally bonded plies. These approaches have shortcomings in providing desired and adequate wet ply bond strength for high caliper product designs having large channels between embossments, less contact area between interply surfaces, wider spacing of plybond lamination points.

Water soluble adhesives including but not limited to polyvinyl alcohol, starch or polyethylene oxide do not have sufficient wet ply bond strength due to inherent water solubility of adhesives.

Increasing adhesive polymer molecular weight or degree of hydrolysis of PVOH to reduce water solubility has a minimum impact of wet ply bond strength. Cross-linking to modify adhesive water solubility and impart wet tack is known in the literature. Borates are very effective cross-linkers for polyvinyl alcohol and starches. However, alkaline salts of borates cannot be blended with poly vinyl alcohol due to immediate cross linking and gel formation which prevents application and causes process hygiene issues. Instead of alkaline salts of borates, low pH route using boric acid is a common approach to blend borates with PVOH and enable an application using the glue applicator in the converting process. However, boric acid cross-linking is delayed and it is not as efficient as high pH alkaline borate route. As result, ply bonding is disrupted during the converting process.

What is needed is a PVOH and borate adhesive composition which can easily be applied to fibrous substrates and has acceptable ply bond strength.

### SUMMARY OF THE INVENTION

A fibrous structure is provided that comprises a ply having a first surface and a second surface; an adhesive composition comprising a borate salt cross-linked polyvinyl alcohol polymer present on the first surface, the cross-linked polymer being a reaction product from the addition of a polyvinyl alcohol, alkaline borate, and cross-linking inhibitor.

A process for producing a multi-ply fibrous structure is provided that comprises providing a ply having a first surface and a second surface; providing PVOH; providing a mixture of alkaline borate salt and cross-linking inhibitor; adding PVOH to the mixture of alkaline borate and sugar alcohol to form an adhesive composition; applying the adhesive composition to the first surface of the absorbent ply.

### BRIEF DESCRIPTION OF THE DRAWINGS

While the specification concludes with claims particularly pointing out and distinctly claiming the subject matter that is regarded as the present disclosure, it is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of elements in any of the exemplary embodiments, except as may be explicitly delineated in the corresponding written description. None of the drawings are necessarily to scale.

FIG. 1 is reaction schematic illustrating prior art adhesive compositions.

FIG. 2 is a reaction schematic illustrating an adhesive composition of the present invention.

FIG. 3 is an illustration on inventive and comparative adhesive compositions.

FIG. 4 is a graph illustrating wet ply bond over dry ply bond ratios.

FIG. 5 shows a process according to the present invention.

FIG. 6 shows a process according to the present invention.

FIG. 7 shows a process according to the present invention.

FIG. 8A shows an adhesive composition application process according to the present invention.

FIG. 8B shows application of adhesive composition to a fibrous structure ply according to a method of the present invention.

FIG. 9A shows an adhesive composition application process according to the present invention.

FIG. 9B shows application of adhesive composition to a fibrous structure ply according to a method of the present invention.

FIG. 10 shows application of adhesive composition to a fibrous structure ply according to a method of the present invention.

FIG. 11 shows a schematic drawing of a tensile tester.

FIG. 12 shows a picture of a tensile tester.

FIG. 13 shows a schematic drawing of a tensile tester.

### DETAILED DESCRIPTION OF THE INVENTION

A variety of consumer products are commonly produced from structures incorporating multiple layers of cellulosic fibrous webs, such as tissue paper webs. These products include paper towels, toilet tissue, facial tissue, napkins, and other absorbent materials, such as materials for absorption of body fluids. This disclosure relates to easily applied cross-linked adhesive compositions for bonding multiple cellulosic fibrous webs together. The bonded webs are useful for production of a variety of consumer products, including those mentioned above. The adhesive compositions disclosed herein are characterized by ease of application, usefulness as laminating binders and by their wet ply bond strength. This disclosure also relates to multi-ply structures incorporating the adhesive compositions disclosed herein, products produced from such structures, and methods of producing the structures.

The adhesive compositions disclosed herein are applicable to all types of cellulosic fibrous webs and products such as paper towels, toilet tissue, facial tissue, napkins, and the like.

The adhesives described herein incorporate a borate salt and sugar alcohol cross-linked polyvinyl alcohol polymer. The adhesive compositions are aqueous solutions incorporating dissolved solids that include from about 2 wt % to about 11 wt. % of the polyvinyl alcohol polymer and from about 0.07 wt. % to about 5.5 wt. % of the borate salt and from about 0.01 wt. % to about 28 wt. % cross-linking inhibitor The polyvinyl alcohol polymer may be a homopolymer or a copolymer incorporating at least one co-monomer such ethylene, methyl acrylate, a carboxylic acid, a branched alkyl acid vinyl ester such as vinyl esters of alpha-branched carboxylic acids having 5 and 9 to 11 carbon atoms available from Resolution Performance Products under the designations VeoVa®, an acryl amide, and other co-monomers. It is understood that the term “copolymer” as used herein is a polymer incorporating at least two monomer units and therefore includes terpolymers and the like.

It is believed that water solubility of plybond adhesives is the key property that limits wet ply bond generation; and that increasing molecular weight and degree of hydrolysis to reduce water solubility of PVOH adhesive is not sufficient to create wet ply bond. In fact this route creates stiff fibrous structures with consumer undesirable surface feel as well as process application challenges due to increased viscosity and process hygiene.

The present invention includes adhesive compositions having wet ply bond strength provided by cross-linking with alkaline sodium borate and cross linking inhibitor blends. Using cross linking inhibitor enable blending alkaline salts of borates with PVOH and application using the existing glue applicator.

“Fibrous structure” as used herein means a structure that comprises one or more fibrous plies. In one example, a fibrous structure according to the present disclosure means an association of fibrous plies that together form a structure capable of performing a function. A nonlimiting example of a fibrous structure of the present disclosure is an absorbent paper product, such as a paper towel, toilet tissue, or other rolled, absorbent paper product.

“Fibrous structure roll” as used herein means a roll of fibrous structure. The fibrous structure roll and thus the fibrous structure comprises a web convolutely wound, for example about a core, in the form of a roll. The core may comprise a wound and overlapping tube of one or more layers comprised of paperboard or other flexible materials, a wooden, metal, glass, plastic, or other composite material sleeve, or an extruded thermoplastic resin. The web may be adhered to the core or wound on the core without adhering to the core. The core may exhibit an outer diameter of less than 2.25 inches and/or less than 2.00 inches and/or less than 1.85 inches and/or less than 2.25 inches to about 1.25 inches and/or less than 2.00 inches to about 1.50 inches and/or less than 1.85 inches to about 1.50 inches. The web may comprise one (a single-ply) or more (a multi-ply) fibrous structure plies, for example two or more fibrous structure plies and/or three or more fibrous structure plies. Such fibrous structure rolls may comprise a plurality of connected, but perforated sheets of fibrous structure (web) that are separably dispensable from adjacent sheets, for example via one or more perforations, for example a plurality of perforations within the fibrous structure (web). The perforations in the fibrous structures of the present invention may be straight and/or shaped perforation lines (areas or lines of weakness in the fibrous structure or web) may be extend ed in the cross-machine direction (CD) and optionally, in the machine direction (MD) and/or diagonally between the CD and MD.

In an example, the fibrous structure is a toilet tissue product (toilet tissue), for example a toilet tissue product that is designed to be flushed down toilets, for example residential toilets, such as tank-type toilets, and to disperse within municipal sewer systems and/or septic systems/tanks. Toilet tissue products are useful as a wiping implement for post-urinary and post-bowel movement cleaning (e.g., toilet tissue, also referred to as bath tissue, and wet wipes), for otorhinolaryngological discharges (e.g., facial tissue), and multi-functional absorbent and cleaning and drying uses. Such a toilet tissue product is void of permanent wet strength and/or levels of permanent wet strength agents, for example polyaminoamide-epichlorohydrin (PAE), which would negatively impact the toilet tissue's decay such that the toilet tissue would exhibit a wet strength decay of 25% or less, more typically a wet strength decay of only about 10-15% during a 30 minute soak test. Such a wet strength decay of 25% or less (typically 10-15%) is unacceptable and undesirable for toilet tissue, which is designed to be flushed down toilets and into septic systems/tanks and/or municipal sewer systems. However, the toilet tissue may comprise a temporary wet strength agent such that the toilet tissue exhibits enough wet strength (temporary wet strength) to meet consumer requirements (doesn't fall apart and/or disperse and/or leak through) during use, for example during the brief time the toilet tissue is wet during use and/or exposed to a relatively small amount of water (not saturated) by a consumer (during wiping, for example after urinating), without causing the toilet tissue to exhibit flushability issues compared to the flushability issues a toilet tissue exhibiting permanent wet strength would encounter. In one example, the toilet tissue of the present invention exhibits a wet strength decay of greater than 60% during a 30 minute soak test (and typically even a wet strength decay of at least 40-60% after 2 minutes during the 30 minute soak test), which is considered “temporary wet strength”, due to the concerns of flushability issues. Temporary wet strength in paper, for example toilet issue, is achieved by adding temporary wet strength agents, for example glyoxylated polyacrylamide, to the toilet tissue.

In another example, the fibrous structure is a paper towel product (paper towel), for example a paper towel product designed to absorb fluids, such as water, while still remaining intact (not dispersing). Paper towel products are designed to not be flushed down toilets and/or to not disperse when wet. Such a paper towel product comprises permanent wet strength and/or levels of permanent wet strength agents, for example polyaminoamide-epichlorohydrin (PAE), which result in the paper towel's exhibiting a wet strength decay of 25% or less, more typically a wet strength decay of only about 10-15% during a 30 minute soak test.

The fibrous structures, for example toilet tissue products, of the present invention may exhibit a sum of MD and CD dry tensile strength of greater than about 59 g/cm (150 g/in) and/or from about 78 g/cm to about 394 g/cm and/or from about 98 g/cm to about 335 g/cm as measured according to the respective Dry Tensile Strength Test Method described herein. In addition, the fibrous structures, for example toilet tissue products, of the present invention may exhibit a sum of MD and CD dry tensile strength of greater than about 196 g/cm and/or from about 196 g/cm to about 394 g/cm and/or from about 216 g/cm to about 335 g/cm and/or from about 236 g/cm to about 315 g/cm as measured according to the respective Dry Tensile Strength Test Method described herein. In one example, the fibrous structures, for example toilet tissue products, of the present invention exhibit a sum of MD and CD dry tensile strength of less than about 394 g/cm and/or less than about 335 g/cm as measured according to the respective Dry Tensile Strength Test Method described herein.

In another example, the fibrous structures, for example paper towel products, of the present invention may exhibit a sum of MD and CD dry tensile strength of greater than about 196 g/cm and/or greater than about 236 g/cm and/or greater than about 276 g/cm and/or greater than about 315 g/cm and/or greater than about 354 g/cm and/or greater than about 394 g/cm and/or from about 315 g/cm to about 1968 g/cm and/or from about 354 g/cm to about 1181 g/cm and/or from about 354 g/cm to about 984 g/cm and/or from about 394 g/cm to about 787 g/cm as measured according to the respective Dry Tensile Strength Test Method described herein.

The fibrous structures, for example toilet tissue products, of the present invention may exhibit an initial sum of MD and CD wet tensile strength of less than about 78 g/cm and/or less than about 59 g/cm and/or less than about 39 g/cm and/or less than about 29 g/cm as measured according to the Wet Tensile Test Method described herein.

The fibrous structures, for example paper towel products, of the present invention may exhibit an initial sum of MD and CD wet tensile strength of greater than about 118 g/cm and/or greater than about 157 g/cm and/or greater than about 196 g/cm and/or greater than about 236 g/cm and/or greater than about 276 g/cm and/or greater than about 315 g/cm and/or greater than about 354 g/cm and/or greater than about 394 g/cm and/or from about 118 g/cm to about 1968 g/cm and/or from about 157 g/cm to about 1181 g/cm and/or from about 196 g/cm to about 984 g/cm and/or from about 196 g/cm to about 787 g/cm and/or from about 196 g/cm to about 591 g/cm as measured according to the Wet Tensile Test Method described herein.

The fibrous structures of the present invention may exhibit a density (based on measuring caliper at 95 g/in²), which may be referred to as a sheet density or web density to distinguish it from the fibrous structure roll's Roll Density, of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

The fibrous structures of the present invention may comprise additives such as surface softening agents, for example silicones, quaternary ammonium compounds, amino silicones, lotions, and mixtures thereof, temporary wet strength agents, permanent wet strength agents, bulk softening agents, wetting agents, latexes, especially surface-pattern-applied latexes, dry strength agents such as carboxymethylcellulose and starch, and other types of additives suitable for inclusion in and/or on fibrous structures.

In one example, the fibrous structures, for example paper towel products, of the present invention exhibits permanent wet strength, for example the fibrous structures comprise a permanent wet strength agent, such as a level of permanent wet strength agent such that the fibrous structures exhibit a wet strength decay of less than 25% and/or less than 20% and/or less than 15% and/or from about 5% to about 25% and/or from about 5% to about 20% and/or from about 10% to about 15% during a 30 minute soak test.

In one example, the fibrous structures, for example toilet tissue products, of the present invention are void of permanent wet strength, for example the fibrous structures exhibit a wet strength decay of greater than 60% and/or greater than 65% and/or greater than 70% and/or greater than 75% and/or greater than 80% during a 30 minute soak test and/or greater than 40% and/or greater than 45% and/or greater than 50% and/or greater than 55% and/or greater than 60% after 2 minutes during the 30 minute soak test. In one example, the fibrous structures, for example toilet tissue products, comprise a temporary wet strength agent, for example a level of temporary wet strength agent, such that the fibrous structures exhibit the wet strength decay described immediately above.

“Web” or “Ply” as used herein means a structure that comprises a plurality of pulp fibers. In one example, the web may comprise a plurality of wood pulp fibers. In another example, the web may comprise a plurality of non-wood pulp fibers, for example plant fibers, synthetic staple fibers, and mixtures thereof. In still another example, in addition to pulp fibers, the web may comprise a plurality of filaments, such as polymeric filaments, for example thermoplastic filaments such as polyolefin filaments (i.e., polypropylene filaments) and/or hydroxyl polymer filaments, for example polyvinyl alcohol filaments and/or polysaccharide filaments such as starch filaments. In one example, a web according to the present invention means an orderly arrangement of fibers alone and with filaments within a structure in order to perform a function.

“Plies” as used herein means two or more individual, integral webs disposed in a substantially contiguous, face-to-face relationship with one another, forming a multi-ply fibrous structure. It is also contemplated that an individual, integral web (fibrous structure) can effectively form a multi-ply fibrous structure, for example, by being folded on itself.

Non-limiting examples of processes for making fibrous structures include known wet-laid papermaking processes, for example conventional wet-pressed papermaking processes and through-air-dried papermaking processes, and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous slurry is then used to deposit a plurality of fibers onto a forming wire, fabric, or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, often referred to as a parent roll, and may subsequently be converted into a finished product, e.g. a single- or multi-ply fibrous structure.

The fibrous structures of the present invention may be homogeneous or may have multiple plies. If multi-ply, the fibrous structures may comprise at least two and/or at least three and/or at least four and/or at least five plies of fiber and/or filament compositions.

In an example, the fibrous structure of the present invention consists essentially of fibers, for example pulp fibers, such as cellulosic pulp fibers and more particularly wood pulp fibers, such as 100% of the fibers present in the fibrous structure are pulp fibers, such as cellulosic pulp fibers and more particularly wood pulp fibers.

In another example, the fibrous structure of the present invention comprises fibers and is void of filaments.

In still another example, the fibrous structures of the present invention comprise filaments and fibers, such as a co-formed fibrous structure.

“Co-formed fibrous structure” as used herein means that the fibrous structure comprises a mixture of at least two different materials wherein at least one of the materials comprises a filament, such as a polypropylene filament, and at least one other material, different from the first material, comprises a solid additive, such as a fiber and/or a particulate. In one example, a co-formed fibrous structure comprises solid additives, such as fibers, such as wood pulp fibers, and filaments, such as polypropylene filaments.

“Fiber” and/or “Filament” as used herein means an elongate particulate having an apparent length greatly exceeding its apparent width, i.e. a length to diameter ratio of at least about 10. In one example, a “fiber” is an elongate particulate as described above that exhibits a length of less than 5.08 cm (2 in.) and a “filament” is an elongate particulate as described above that exhibits a length of greater than or equal to 5.08 cm (2 in.).

Fibers are typically considered discontinuous in nature. Non-limiting examples of fibers include pulp fibers, such as wood pulp fibers, and synthetic staple fibers such as polyester fibers.

Filaments are typically considered continuous or substantially continuous in nature. Filaments are relatively longer than fibers. Non-limiting examples of filaments include melt blown and/or spun bond filaments. Non-limiting examples of materials that can be spun into filaments include natural polymers, such as starch, starch derivatives, cellulose and cellulose derivatives, hemicellulose, hemicellulose derivatives, and synthetic polymers including, but not limited to polyvinyl alcohol filaments and/or polyvinyl alcohol derivative filaments, and thermoplastic polymer filaments, such as polyesters, nylons, polyolefins such as polypropylene filaments, polyethylene filaments, and biodegradable or compostable thermoplastic fibers such as polylactic acid filaments, polyhydroxyalkanoate filaments and polycaprolactone filaments. The filaments may be monocomponent or multicomponent, such as bicomponent filaments.

In an example of the present invention, “fiber” refers to papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified fibrous structure. U.S. Pat. Nos. 4,300,981 and 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking.

In an example, the wood pulp fibers are selected from the group consisting of hardwood pulp fibers, softwood pulp fibers, and mixtures thereof. The hardwood pulp fibers may be selected from the group consisting of: tropical hardwood pulp fibers, northern hardwood pulp fibers, and mixtures thereof. The tropical hardwood pulp fibers may be selected from the group consisting of: eucalyptus fibers, acacia fibers, and mixtures thereof. The northern hardwood pulp fibers may be selected from the group consisting of: cedar fibers, maple fibers, and mixtures thereof.

In addition to the various wood pulp fibers, other cellulosic fibers such as cotton linters, rayon, lyocell, trichomes, seed hairs, and bagasse can be used in this invention. Other sources of cellulose in the form of fibers or capable of being spun into fibers include grasses and grain sources.

“Trichome” or “trichome fiber” as used herein means an epidermal attachment of a varying shape, structure and/or function of a non-seed portion of a plant. In one example, a trichome is an outgrowth of the epidermis of a non-seed portion of a plant. The outgrowth may extend from an epidermal cell. In one embodiment, the outgrowth is a trichome fiber. The outgrowth may be a hairlike or bristlelike outgrowth from the epidermis of a plant.

Trichome fibers are different from seed hair fibers in that they are not attached to seed portions of a plant. For example, trichome fibers, unlike seed hair fibers, are not attached to a seed or a seed pod epidermis. Cotton, kapok, milkweed, and coconut coir are non-limiting examples of seed hair fibers.

Further, trichome fibers are different from nonwood bast and/or core fibers in that they are not attached to the bast, also known as phloem, or the core, also known as xylem portions of a nonwood dicotyledonous plant stem. Non-limiting examples of plants which have been used to yield nonwood bast fibers and/or nonwood core fibers include kenaf, jute, flax, ramie and hemp.

Further trichome fibers are different from monocotyledonous plant derived fibers such as those derived from cereal straws (wheat, rye, barley, oat, etc.), stalks (corn, cotton, sorghum, Hesperaloe funifera, etc.), canes (bamboo, bagasse, etc.), grasses (esparto, lemon, sabai, switchgrass, etc), since such monocotyledonous plant derived fibers are not attached to an epidermis of a plant.

Further, trichome fibers are different from leaf fibers in that they do not originate from within the leaf structure. Sisal and abaca are sometimes liberated as leaf fibers.

Finally, trichome fibers are different from wood pulp fibers since wood pulp fibers are not outgrowths from the epidermis of a plant; namely, a tree. Wood pulp fibers rather originate from the secondary xylem portion of the tree stem.

“Basis Weight” as used herein is the weight per unit area of a sample reported in lbs/3000 ft² or g/m² (gsm) and is measured according to the respective Basis Weight Test Method described herein.

“Machine Direction” or “MD” as used herein means the direction parallel to the flow of the fibrous structure through the web (fibrous structure) making machine and/or fibrous structure manufacturing equipment.

“Cross Machine Direction” or “CD” as used herein means the direction parallel to the width of the web (fibrous structure) making machine and/or fibrous structure manufacturing equipment and perpendicular to the machine direction.

“Embossed” as used herein with respect to a web and/or fibrous structure means that a web and/or fibrous structure of the present invention has been subjected to a process which converts a smooth surfaced web and/or fibrous structure to a decorative surface by replicating a design on one or more emboss rolls, which form a nip through which the web and/or fibrous structure passes. Embossed does not include creping, microcreping, printing or other processes that may also impart a texture and/or decorative pattern to a web and/or fibrous structure.

“Differential density”, as used herein, means a web and/or fibrous structure of the present invention that comprises one or more regions of relatively low fiber density, which are referred to as pillow regions, and one or more regions of relatively high fiber density, which are referred to as knuckle regions.

“Densified”, as used herein means a portion of a web and/or fibrous structure of the present invention that is characterized by regions of relatively high fiber density (knuckle regions).

“Non-densified”, as used herein, means a portion of a web and/or fibrous structure of the present invention that exhibits a lesser density (one or more regions of relatively lower fiber density) (pillow regions) than another portion (for example a knuckle region) of the web and/or fibrous structure.

“Creped” as used herein means creped off of a Yankee dryer or other similar roll and/or fabric creped and/or belt creped. Rush transfer of a web (fibrous structure) alone does not result in a “creped” fibrous structure for purposes of the present invention.

Non-limiting examples of processes for making fibrous structures include known wet-laid papermaking processes, air-laid papermaking processes, and wet, solution, and dry filament spinning processes, for example melt blowing and spun bonding spinning processes, that are typically referred to as nonwoven processes. Such processes may comprise the steps of preparing a fiber composition in the form of a suspension in a medium, either wet, more specifically aqueous medium, or dry, more specifically gaseous, i.e. with air as medium. The aqueous medium used for wet-laid processes is oftentimes referred to as fiber slurry. The fibrous suspension is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking and may subsequently be converted into a finished product (e.g., a fibrous structure).

“Fibrous element” as used herein means an elongate particulate having a length greatly exceeding its average diameter, i.e. a length to average diameter ratio of at least about 10. A fibrous element may be a filament or a fiber. In one example, the fibrous element is a single fibrous element rather than a yarn comprising a plurality of fibrous elements.

The fibrous elements of the present disclosure may be spun from polymer melt compositions via suitable spinning operations, such as melt blown and/or spun bonding and/or they may be obtained from natural sources such as vegetative sources, for example trees.

The fibrous elements of the present disclosure may be monocomponent and/or multicomponent. For example, the fibrous elements may comprise bicomponent fibers and/or filaments. The bicomponent fibers and/or filaments may be in any form, such as side-by-side, core and sheath, islands-in-the-sea and the like.

“Filament” as used herein means an elongate particulate as described above that exhibits a length of greater than or equal to 5.08 cm (2 in.) and/or greater than or equal to 7.62 cm (3 in.) and/or greater than or equal to 10.16 cm (4 in.) and/or greater than or equal to 15.24 cm (6 in.).

Filaments are typically considered continuous or substantially continuous in nature. Filaments are relatively longer than fibers. Non-limiting examples of filaments include melt blown and/or spun bond filaments. Non-limiting examples of polymers that may be spun into filaments include natural polymers, such as starch, starch derivatives, cellulose, such as rayon and/or lyocell, and cellulose derivatives, hemicellulose, hemicellulose derivatives, and synthetic polymers including, but not limited to polyvinyl alcohol, thermoplastic polymer, such as polyesters, nylons, polyolefins such as polypropylene filaments, polyethylene filaments, and biodegradable thermoplastic fibers such as polylactic acid filaments, polyhydroxyalkanoate filaments, polyesteramide filaments and polycaprolactone filaments.

“Fiber” as used herein means an elongate particulate as described above that exhibits a length of less than 5.08 cm (2 in.) and/or less than 3.81 cm (1.5 in.) and/or less than 2.54 cm (1 in.). A fiber may be elongate physical structure having an apparent length greatly exceeding its apparent diameter (i.e., a length to diameter ratio of at least about 10.) Fibers having a non-circular cross-section and/or tubular shape are common; the “diameter” in this case is the diameter of a circle having a cross-sectional area equal to the cross-sectional area of the fiber.

Fibers are typically considered discontinuous in nature. Non-limiting examples of fibers include pulp fibers, such as wood pulp fibers, and synthetic staple fibers such as polypropylene, polyethylene, polyester, copolymers thereof, rayon, glass fibers and polyvinyl alcohol fibers.

Staple fibers may be produced by spinning a filament tow and then cutting the tow into segments of less than 5.08 cm (2 in.) thus producing fibers.

In one example of the present disclosure, a fiber may be a naturally occurring fiber, which means it is obtained from a naturally occurring source, such as a vegetative source, for example a tree and/or other plant. Such fibers are typically used in papermaking and are oftentimes referred to as papermaking fibers. Papermaking fibers useful in the present disclosure include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to fibrous structures made therefrom. Pulps derived from both deciduous trees (hereinafter, also referred to as “hardwood”) and coniferous trees (hereinafter, also referred to as “softwood”) may be utilized. The hardwood and softwood fibers may be blended, or alternatively, may be deposited in layers to provide a stratified web. Also applicable to the present disclosure are fibers derived from recycled paper, which may contain any or all of the above categories of fibers as well as other non-fibrous polymers such as fillers, softening agents, wet and dry strength agents, and adhesives used to facilitate the original papermaking.

In addition to the various wood pulp fibers, other cellulosic fibers such as cotton linters, rayon, lyocell, and bagasse fibers may be used in the fibrous structures of the present disclosure.

In an example, fibrous structures rolled about a fibrous core of the present disclosure may have a basis weight between about 10 g/m² to about 160 g/m² or from about 20 g/m² to about 150 g/m² or from about 35 g/m² to about 120 g/m² or from about 55 to 100 g/m², specifically reciting all 0.1 g/m² increments within the recited ranges. In addition, the fibrous structures may have a basis weight between about 40 g/m² to about 140 g/m² and/or from about 50 g/m² to about 120 g/m² and/or from about 55 g/m² to about 105 g/m² and/or from about 60 to 100 g/m², specifically reciting all 0.1 g/m² increments within the recited ranges, as measured according to the respective Basis Weight Test Method described herein. Other basis weights for other materials, such as wrapping paper and aluminum foil, are also within the scope of the present disclosure.

“Basis Weight” as used herein is the weight per unit area of a sample reported in lbs/3000 ft² or g/m². Basis weight may be measured by preparing one or more samples to create a total area (i.e., flat, in the material's non-cylindrical form) of at least 100 in² (accurate to +/−0.1 in²) and weighing the sample(s) on a top loading calibrated balance with a resolution of 0.001 g or smaller. The balance is protected from air drafts and other disturbances using a draft shield. Weights are recorded when the readings on the balance become constant. The total weight (lbs or g) is calculated and the total area of the samples (ft² or m²) is measured. The basis weight in units of lbs/3,000 ft² is calculated by dividing the total weight (lbs) by the total area of the samples (ft²) and multiplying by 3000. The basis weight in units of g/m2 is calculated by dividing the total weight (g) by the total area of the samples (m²).

“Density” as used herein is calculated as the quotient of the Basis Weight expressed in grams per square meter divided by the Caliper expressed in microns. The resulting Density is expressed as grams per cubic centimeter (g/cm³ or g/cc). Fibrous structures of the present disclosure may have a density of greater than about 0.05 g/cm³ and/or greater than 0.06 g/cm³ and/or greater than 0.07 g/cm³ and/or less than 0.10 g/cm³ and/or less than 0.09 g/cm³ and/or less than 0.08 g/cm³ and/or less than 0.60 g/cm³ and/or less than 0.30 g/cm³ and/or less than 0.20 g/cm³ and/or less than 0.15 g/cm³ and/or less than 0.10 g/cm³ and/or less than 0.07 g/cm³ and/or less than 0.05 g/cm³ and/or from about 0.01 g/cm³ to about 0.20 g/cm³ and/or from about 0.02 g/cm³ to about 0.15 g/cm³ and/or from about 0.02 g/cm³ to about 0.10 g/cm³.

All temperatures herein are in degrees Celsius (° C.) unless otherwise indicated. Unless otherwise specified, all measurements herein are conducted at room temperature (about 23° C.) and under atmospheric pressure.

In all embodiments of the present disclosure, all percentages are by weight of the total composition, unless specifically stated otherwise. All ratios are weight ratios, unless specifically stated otherwise.

“Percent Solids” as used herein is defined as the percentage of solid material present within a given volume of water sample or solvent. It can be measured using a moisture analyzer that determines the moisture content with the loss on drying method. The instrument heats the sample while monitoring its weight loss until the samples reaches to a stable, moisture-free stage. One can also use a gravimetric analysis that involves evaporating a water sample in an oven at elevated temperatures and weighing the remaining residue with a precision balance.

The weight average molecular weight of a polymer is an average molecular weight of all the polymer chains in the sample and it is defined by:

$$Mw = \sum {N}_{1} {M}_{i}^{2} / \sum {N}_{i} {M}_{i}$$

Mw is determined by methods that are sensitive to the molecular size such as light scattering techniques, for example by Gel Permeation Chromatography with Multi-Angle Light Scattering and Refractive Index Detection (GPC-MALS/RI) for PVOH Polymer Molecular Weight Distribution Measurement, as described below.

Gel Permeation Chromatography (GPC) with Multi-Angle Light Scattering (MALS) and Refractive Index (RI) Detection (GPC-MALS/RI) permits the measurement of absolute molecular weight of a polymer without the need for column calibration methods or standards. The GPC system allows molecules to be separated as a function of their molecular size. MALS and RI allow information to be obtained on the number average (Mn) and weight average (Mw) molecular weight. The Mw distribution of water-soluble polymers like PVOH is typically measured by using a Liquid Chromatography system (e.g., Agilent 1260 Infinity pump system with OpenLab Chemstation software, Agilent Technology, Santa Clara, CA, USA) and a column set (e.g., two Waters Ultrahydrogel Linear columns, 7.8×300 mm (Part #WAT 011545) in series) which is operated at 40° C. The mobile phase is 0.1M sodium nitrate in water containing 0.02% sodium azide. The mobile phase solvent is pumped at a flow rate of 1 mL/min, isocratically. A multiangle light scattering (18-Angle MALS) detector DAWN® and a differential refractive index (RI) detector (Wyatt Technology of Santa Barbara, Calif., USA) controlled by Wyatt Astra® software v8.0 are used. A sample is typically prepared by dissolving PVOH materials in the mobile phase at ˜1 mg per ml and by mixing the solution for overnight hydration at room temperature. The sample is filtered through a 0.8 μm Versapor membrane filter (PALL, Life Sciences, NY, USA) into the LC autosampler vial using a 3-ml syringe before the GPC analysis. A dn/dc value (differential change of refractive index with concentration, 0.145) is used for the number average (Mn), weight average molecular weight (Mw) and polydispersity (Mw/Mn) determination by the Astra detector software.

As used herein, the articles including “a” and “an” when used in a claim, are understood to mean one or more of what is claimed or described.

As used herein, the terms “include”, “includes” and “including” are meant to be non-limiting.

Unless otherwise noted, all component or composition levels are in reference to the active portion of that component or composition, and are exclusive of impurities, for example, residual solvents or by-products, which may be present in commercially available sources of such components or compositions.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

As used herein, the word “or” when used as a connector of two or more elements is meant to include the elements individually and in combination; for example X or Y, means X or Y or both.

By “μm” or “microns” as used herein is meant micrometer.

Polyvinyl alcohol-based adhesives are well known in the prior art, as aqueous polyvinyl alcohol adhesives find widespread use in bonding cellulosic and other porous materials. As such, polyvinyl alcohol based adhesives are widely used in paper converting applications such as tissue, fiber board and box board laminating, corrugating operations, bag manufacturing and in many other applications such as book binding, wallpaper pastes. Water solubility of polyvinyl alcohol is a key limitation in creating products having high wet ply bond. Water soluble low pH boron compounds are well known additives for polyvinyl alcohol adhesives to increase the wet tack of the adhesives discussed in detail in other references, for example U.S. Pat. No. 3,135,648. Alkaline borates are more effective crosslinkers, but the use of suitable water-soluble boron compounds in conjunction with polyvinyl alcohol adhesives are limited to adhesive compositions with a pH<5.5, as the adhesive composition gels if the pH of the system goes above 5.5. As the pH of the polyvinyl alcohol/water soluble boron compound adhesive composition increases above 5.5, the whole adhesive mass thickens with a loss of wetting ability and ultimately sets into a thick rubbery gel causing significant operational and application challenges. However, the use of low pH polyvinyl alcohol and water-soluble blends can cause difficulties in storage and handling due to corrosion of the mixing vessels, pumps, and the conduits which are in contact with the acidic low pH adhesive compositions. Such potential corrosion may also involve the adhesive application equipment, causing pitting of the application rolls, wiping blades, and nip rolls, necessitating the continued replating or replacement of these parts. Another disadvantage of using acidic low pH polyvinyl alcohol and water-soluble borated adhesives is that these materials attack the cellulosic substrate thereby weakening the bonded substrate.

The present invention overcomes these deficiencies by providing polyvinyl alcohol adhesive compositions containing high pH water soluble borate compound.

Without wishing to be bound by theory, it is believed that when a cross-linking inhibitor is added to polyvinyl alcohol or a borate compound, the cross-linking inhibitor interacts with the hydroxyl (—OH) sites of the polyvinyl alcohol or borate compound, e.g., by forming hydrogen bonds. As used herein, a “cross-linking inhibitor” is a compound that inhibits cross-linking between polyvinyl alcohol and borate compounds. Because at least some of the hydroxyl sites of the polyvinyl alcohol or borate are occupied by the cross-linking inhibitor, cross-linking between the polyvinyl alcohol and borate is reduced resulting in a stable material that can be processed using a single glue application to create water resilient bonding.

The weight percentage ratio of PVOH to alkaline borate plus cross-linking inhibitor (PVOH/Sodium borate+cross-linking inhibitor ratio) is defined by P1 and it ranges from about 2:1 to about 30:1. The weight percentage ratio of alkaline borate to cross-linking inhibitor is defined by P2 (Sodium borate to cross-linking inhibitor ratio) and it ranges from about 1:5 to about 5:1.

Ratios of PVOH to alkaline borate, P1 and alkaline borate to cross-linking inhibitor ratio, P2 are important to manage ideal wet ply bond properties and material processability. P1 is used to optimize degree of cross-linking while P2 is utilized to manage blended formulation stability and processability. P1 could range from 5:1 to 30:1 more preferably greater than 10:1

In embodiments, the polyvinyl alcohol polymers described herein have a degree of polymerization of about 300 to about 4,000, number average molecular weights of about 13,300 to about 400,000 and are from about 88 mole % to about 99.9 mole % hydrolyzed. In another embodiment, the polyvinyl alcohol polymers described herein have a degree of polymerization of about 1,600 to about 2,600, number average molecular weights of about 70,000 to about 116,000 and are from about 95 mole % to about 99.9 mole % hydrolyzed.

Exemplary polyvinyl alcohol polymers useful for inclusion in the adhesive compositions described herein are available from Kuraray under the designation Elvanol 71-30, Elvanol 75-15, Elvanol 80-18. Elvanol 85-82, Elvanol 90-50, Poval 5-74, Poval32-80, Poval 5-82, Poval 4-88, Poval 22-88, Poval; 49-88, Poval 100-88, Poval 27-96; Celanese Chemicals under the designations SM 73, MH82, and SH95EXP. These polyvinyl alcohol polymers are tackified PVOH grades. SM73 has a viscosity 1200 to 1600 cps@10% solids and 20° C., and a pH of 4.0 to 4.7; MH82 has a viscosity of 4200 to 5900 cps@10% solids and 20° C., and a pH of 4.4 to 4.9; and SH95EXP has a viscosity of 65 to 105 cps@4.0% solids and 20° C. and a pH of 4 to 5.5.

The addition of one or more cross-linking inhibitors may occur at any suitable time. For example, a cross-linking inhibitor may be added by an adhesive manufacturer prior to shipping an adhesive to a product manufacturer which creates the final blend by combining with a borate cross linker.

A cross-linking inhibitor and borate cross linker may be combined and added to an adhesive by the adhesive manufacturer prior to shipping the final blend to the product manufacturer. The product manufacturer may add a cross-linking inhibitor and borate cross linker blend to an adhesive in advance of making the product composition. The product manufacturer may combine the adhesive, borate cross linker, and cross-linking inhibitor as part of an in-line step of the product manufacturing process. For example, in a single manufacturing process a borate cross linker may be combined with cross-linking inhibitor to form a first composition, and then the first composition sequentially combined with the second composition containing adhesive.

As used in the present disclosure, a “borate compound” is a compound that comprises borate or that is capable of providing borate in solution. The borate compound may be any compound that is suitable for inclusion in a desired adhesive composition.

Borate compounds may include boric acid, boric acid derivatives, boronic acid, boronic acid derivatives, and combinations thereof Boric acid has the chemical formula H3BO3 (sometimes written as B(OH)3). Boric acid derivatives include boron-containing compounds where at least a portion of the compound is present in solution as boric acid or a chemical equivalent thereof. Suitable boric acid derivatives include alkaline high pH borates can include alkali metal borates such as sodium, potassium and cesium salts of octaborate, tetraborate, metaborate, pentaborate). MEA-borate (i.e., monoethanolamine borate), borax, boric oxide, tetraborate decahydrate, tetraborate pentahydrate, and mixtures thereof.

Boronic acid has the chemical formula R—B(OH)₂, where R is a non-hydroxyl substituent group. R may be at least one of substituted or unsubstituted C6-C10 aryl groups or substituted or unsubstituted Ci-ClO alkyl groups. R may be at least one of substituted or unsubstituted C6 aryl groups or substituted or unsubstituted C1-C4 alkyl groups. The boronic acid may be at least one of phenylboronic acid, ethylboronic acid, 3-nitrobenzeneboronic acid, or mixtures thereof.

The boronic acid may be a compound according to Formula I:

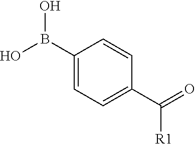

wherein R1 is at least one of hydrogen, hydroxy, C1-C6 alkyl, substituted C1-C6 alkyl, C2-C6 alkenyl or substituted C2-C6 alkenyl. Ri may be a C1-C6 alkyl, in particular wherein R′ is CH3, CH3CH2 or CH3CH2CH2, or wherein R′ is hydrogen. The boronic acid may include 4-formyl-phenyl-boronic acid (4-FPBA). The boronic acid may be at least one of: thiophene-2 boronic acid, thiophene-3 boronic acid, acetamidophenyl boronic acid, benzofuran-2 boronic acid, naphtalene-1 boronic acid, naphtalene-2 boronic acid, 2-FPBA, 3-FBPA, 4-FPBA, 1-thianthrene boronic acid, 4-dibenzofuran boronic acid, 5-methylthiophene-2 boronic, acid, thionaphtrene boronic acid, furan-2 boronic acid, furan-3 boronic acid, 4,4 biphenyl-diborinic acid, 6-hydroxy-2-naphtalene, 4-(methylthio) phenyl boronic acid, 4 (trimethyl-silyl)phenyl boronic acid, 3-bromothiophene boronic acid, 4-methylthiophene boronic acid, 2-naphtyl boronic acid, 5-bromothiphene boronic acid, 5-chlorothiophene boronic acid, dimethylthiophene boronic acid, 2-bromophenyl boronic acid, 3-chlorophenyl boronic acid, 3-methoxy-2-thiophene, p-methyl-phenylethyl boronic acid, 2-thianthrene boronic acid, di-benzothiophene boronic acid, 4-carboxyphenyl boronic acid, 9-anthryl boronic acid, 3,5 dichiorophenyl boronic, acid, diphenyl boronic acidanhydride, o-chlorophenyl boronic acid, p-chlorophenyl boronic acid, m-bromophenyl boronic acid, p-bromophenyl boronic acid, p-flourophenyl boronic acid, p-tolyl boronic acid, o-tolyl boronic acid, octyl boronic acid, 1,3,5 trimethylphenyl boronic acid, 3-chloro-4-flourophenyl boronic acid, 3-aminophenyl boronic acid, 3,5-bis-(triflouromethyl)phenyl boronic acid, 2,4 dichlorophenyl boronic acid, 4-methoxyphenyl boronic acid, or combinations thereof.

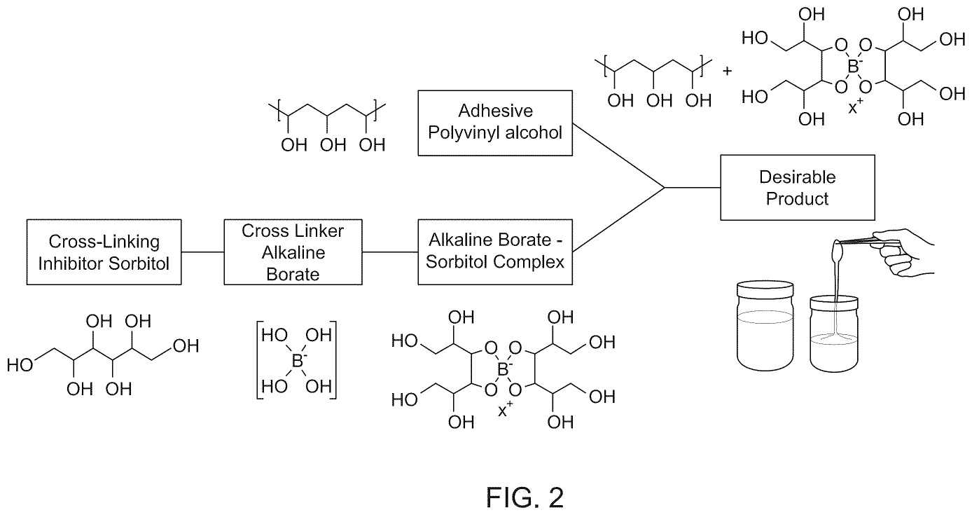

The methods and compositions described herein include a cross-linking inhibitor. Without wishing to be bound by theory, it is believed that when added to a composition that contains polyvinyl alcohol or a borate compound, the cross-linking inhibitor interacts with the hydroxyl (—OH) sites of the polyvinyl alcohol or borate compound, e.g., by forming hydrogen bonds (FIG. 2). Because at least some of the hydroxyl sites of the polyvinyl alcohol or borate are occupied by the cross-linking inhibitor, cross-linking between the polyvinyl alcohol and borate is reduced when they are combined.

As described above, a suitable cross-linking inhibitor will occupy at least some of the hydroxyl sites of the polyvinyl alcohol and/or at least some of the hydroxyl sites of the borate compound. Suitable cross-linking inhibitors may include moieties capable of forming hydrogen bonds with polyvinyl alcohol and/or borate. Typically, the cross-linking inhibitors will include at least two moieties capable of forming hydrogen bonds. The at least two moieties may be spaced at least three carbon atoms apart. The at least two moieties may be spaced by no more than five carbon atoms apart. Without wishing to be bound by theory, it is believed that cross-linking inhibition improves when the spacing of the hydrogen-bond-forming moieties aligns with the spacing of the hydroxyl groups of the polyvinyl alcohol.

Suitable moieties that are capable of forming hydrogen bonds include moieties independently comprising at least one of: —OH, —S03, —NH2, —COOH, or combinations thereof. The at least one, or at least two, of the moieties may be hydroxyl groups (—OH). The moieties, e.g. the hydroxyl groups, may be spaced three carbon atoms apart, although there may be a moiety, such as a hydroxyl group, on the intermediate carbon as well. The hydrogen-bond-forming moieties of the cross-linking inhibitor may be the same, or they may be different. At least one of the hydrogen-bond-forming moieties may be at a terminal position of the cross-linking inhibitor.

The cross-linking inhibitor may be a polyol. As used herein, a “polyol” is a compound that has at least two hydroxyl groups. The polyol may include at least two hydroxyl groups that are separated by three carbon atoms, for example, HO—CH—CH2-CH—OH. The polyol may be described as an at least “n, n+2 hydroxyl” polyol meaning that the polyol has a hydroxyl group at an “n” position and a hydroxyl group at an “n+2” position. It is understood that additional hydroxyl groups may be present (e.g., at the “n+1” position, the “n−i” position, the “n+2” position, etc.). The polyol may be a “n, n+2 diol”, where the diol has from 3 to i2, or from 3 to i0, or from 3 to 8, or from 3 to 6 carbons; for example, i,3-propanediol; i,3-butanediol; and 2,4-butanediol. At least one of the at least two hydroxyl groups may be at a terminal position of the cross-linking inhibitor.

The cross-linking inhibitor may be a polyol having from three to twenty carbon atoms, or from three to twelve carbon atoms, or from three to nine carbon atoms, or from three to six carbon atoms. The polyol may have a weight average molecular weight of less than the polyvinyl alcohol, e.g., less than about 20,000 or less than about 10,000 or less than about 5,000 or less than about 1,000 Daltons.

It may be desirable for a cross-linking inhibitor to have some, hydrogen-bond forming groups (such as —OH) so that it can interact with the PVOH and/or borate derivatives, but not too many such groups, as the groups may form intra- and inter-molecular hydrogen bonds and become semi- or fully-crystalline (FIG. 2). Crystallinity may result in challenges in effectively adding and/or dispersing the cross-linking inhibitor in the adhesive compositions described herein. Therefore, a cross-linking inhibitor may be a liquid at room temperature (i.e., 20° C.).

The polyol may be at least one of: glycerol; 1,2-hexanediol, 2, 3-butanediol; 2-methyl,3-propanediol; 2, 4-pentanediol; 1,3-propanediol; N-methyl-D-glucamine; 2-amino-1,3-propanediol; 2-hydroxymethyl-1,3-propanediol; 2-amino-1,3-propanediol; or combinations thereof.

A cross-linking inhibitor may comprise an alkoxylated polyol. The alkoxylating groups may be ethoxylate groups, propoxylate groups, or mixtures thereof.

A cross-linking inhibitor may have a structure according to Formula (I):

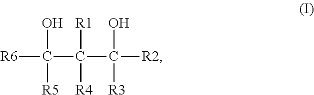

where each of R1-R6 is at least one of a C1-C8 alkyl, a C1-C8 hydroxylated alkyl, an alkoxylated C1-C8 alkyl, an aryl group, an aryl hydroxyl, a hydrogen, or a hydroxyl group. Each of R1-R6 may be independently selected from a C1-C3 alkyl, a C1-C3 hydroxylated alkyl group, a hydrogen, or a hydroxyl group. R1 may be a hydrogen or a hydroxyl group; R3, R4, and/or R5 may be a hydrogen; and R2 and R6 may each be independently at least one of hydrogen, a C1-C3 alkyl group, or a C1-C3 hydroxylated alkyl group. R2, R3, R5, and R6 may be hydrogen, and R1 and R4 may each be independently at least one of a hydrogen, a hydroxyl, or a C1-C3 hydroxylated alkyl, such as a methanol group.

A cross-linking inhibitor may have a structure according to Formula (II):

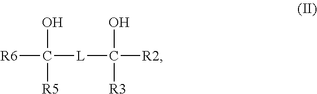

where L is at least one of carbon, nitrogen, or oxygen, and where each R group is independently at least one of a C1-C8 alkyl, a C1-C8 hydroxylated alkyl, an alkoxylated C1-C8 alkyl, an aryl group, an aryl hydroxyl, a hydrogen, or a hydroxyl group. Each R group may be independently at least one of a C1-C3 alkyl, a C1-C3 hydroxylated alkyl group, a hydrogen, or a hydroxyl group. R3 and R5 may each be hydrogen; and R2 and R6 may be independently at least one of hydrogen, a C1-C3 alkyl group, or a C1-C3 hydroxylated alkyl group. R2, R3, R5, and R6 may be hydrogen, and R1 and R4 may each be a hydrogen, a hydroxyl, or a C1-C3 hydroxylated alkyl, such as a methanol group.

A cross-linking inhibitor may have a structure according to Formula (III):

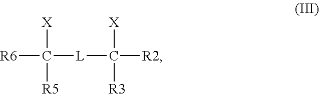

where each X is independently at least one of —OH, NH2, 55 SH, and COOH, where L is at least one of carbon, nitrogen, or oxygen, and where each R group is independently at least one of a C1-C8 alkyl, a C1-C8 hydroxylated alkyl, an alkoxylated C1-C8 alkyl, an aryl group, an aryl hydroxyl, a hydrogen, or a hydroxyl group. Each R group may be independently at least one of a C1-C3 alkyl, a C1-C3 hydroxylated alkyl group, a hydrogen, or a hydroxyl group. R3 and R5 may each be hydrogen; and R2 and R6 may be independently at least one of hydrogen, a C1-C3 alkyl group, or a Ci-C3 hydroxylated alkyl group. R2, R3, R5, and R6 may be hydrogen, and R1 and R4 may each be a hydrogen, a hydroxyl, or a Ci-C3 hydroxylated alkyl, such as a methanol group.

The adhesive compositions herein may comprise from about 0.1% to about 20%, or from about 0.5% to about 10%, or from about 0.75% to about 4%, or from about 1% to about 2%, by weight of the composition, of the cross-linking inhibitor. The adhesive compositions described herein may comprise a sufficient amount of the cross-linking inhibitor so that the molar ratio of the cross-linking inhibitor to the borate derivative is at least about 1.5:1, or at least about 2:1.

The polyvinyl alcohol polymers useful for inclusion in the adhesives described herein are borated by reaction with a boron compound. Exemplary suitable boron compounds are methyl borate, boron trifluoride, boric anhydride, pyroborates, peroxoborates and boranes. In embodiments, the boron compound is sodium tetraborate decahydrate (borax).

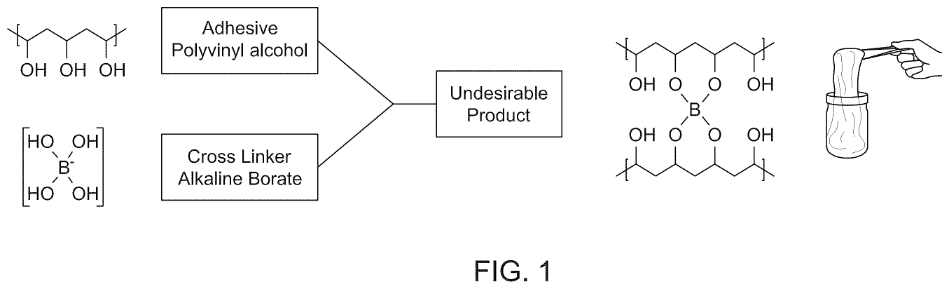

Borating polyvinyl alcohol is useful to control the viscosity of the polyvinyl alcohol adhesive composition. This viscosity regulation is provided by the formation of a complex between boric ion and hydroxyl groups in the polyvinyl alcohol polymer (FIG. 1). At pH's above 8, the borate ion exists and is available to cross-link and cause gelling of the adhesive composition. At lower pH's, the borate is tied up by hydrogen and is not available for cross-linking, thus gelation caused by borate ion is reversible. By borating the polyvinyl alcohol, a gelled adhesive composition may be produced that can be easily applied to and/or adhered to the cellulosic web. In embodiments adhesive compositions of the present invention may have viscosities at 1 l/s shear rate and 70° C. of from about 15 cps to about 2000 cps, about 100 cps to about 1800 cps, about 500 cps to about 1500 cps, about 700 cps to about 1,000 cps, up to about 2,000 cps, up to about 1,800 cps, up to about 1,700 cps, up to about 1,500 cps, or up to about 1,250 cps.

As shown in FIG. 4, cross-linking PVOH with borate increases molecular weight and elasticity of PVOH while decreasing its water solubility and improves its adhesion to cellulose fibers, especially when wet, resulting in increased dry and wet ply bond and increased wet/dry ply bond ratio. The increased elasticity enables towels having multiple plies bound together by cross-linked PVOH to survive the force imparted during cleaning and through the converting process. Desired dry ply bond can vary from approxomately 10 g/inch to approximately 40 g/inch. Desired wet ply bond can range from approximately 0.5 g/inc to approximately 14 g/inc. Desired Wet/Dry ply bond ratio can vary between approximately 0.05 to 1.0.

Borate cross-linked PVOH displays an unusual shear thickening rheological behavior (most of cross-linked chemistries show shear thinning behavior). This shear thickening behavior which manifests itself during converting lamination process allows the cross-linked adhesive to be retained on the (interior) surface of a towel, and potentially less rewetting and swelling of the fiber network (especially pillows).

Cross-linking can begin immediately in the presence of water, resulting in increased bond strength on the converting line to survive processing strains, however cross-linking bonds are not permanent, rather they form temporary wet ply bonds (TWPD).

In embodiments, the boric acid may be used as the borating agent and the boric acid may be incorporated into the adhesive formulation at a concentration of from about 3.0 wt. % to about 15.0 wt. % based upon the total weight of the polyvinyl alcohol polymer. In another embodiment, the boric acid may be incorporated into the adhesive formulations at a concentration of from about 4.0 wt. % to about 10.0 wt. % based upon the total weight of the polyvinyl alcohol polymer. In still another embodiment, the boric acid may be incorporated into the adhesive formulations at a concentration of from about 4.0 wt. % to about 7.0 wt. % based upon the total weight of the polyvinyl alcohol polymer.

Instead of alkaline salts of borates, low pH route using boric acid is a common approach to blend borates with PVOH and enable an application using the glue applicator in the converting process.

Adhesive compositions of the Present Invention can include polyols such as PVOH, water-based naturals or animal based including starch (dextrin), protein (casein), polyethylene oxide.

Adhesive compositions of the Present Invention can include other adhesives such as vinyl acetate, vinyl ethylene acetate, vinyl acetate acrylic, polyacrylates, rubber latexes, polyurethane emulsions or dispersion, polyvinylidene chloride, styrene-butadiene copolymers, polychloroprene.

Boric acid and its derivatives such as borate ions are able to react with 1,2-diol, 1,3-diol, or polyols to form reversible/transient boronic ester bonds, and the interconversion between boric acid-diol and boronic ester bonds can be achieved by adjusting the pH of the aqueous solution. Therefore, boronic ester bonds are often used to design self-healing hydrogels. Borax complexation is usually specific for vicinal cis diols, that is, molecules with hydroxyl groups in a cis-type arrangement.

Borate ions react with —OH groups on PVOH creating cross-links of cyclic borate ester bonds. Mixing poly(vinyl alcohol) (PVOH) with sodium borate (or other weak Lewis acids such boric acid, aluminum chloride, zirconium chloride, titanium chloride forms cross-links between polymer chains due to the creation of weak bonds to the OH groups of PVOH. The three-dimensional network polymers formed as a result lead to the viscoelastic nature of the fluid. The sodium borate interlinks with the PVOH through hydrogen bonds or reversible covalent bonds to form “di-diol” complexes, which constitute two diol units and one borate ion, yielding the gel-like material. The linkage is proposed to be of two types: (a) where the linkage between diols and borate ions is based on both, a physical and chemical nature and (b) where only a chemical bond exists in the form of cross-links between PVA polymers and borate ions.

PVOH cross linked with sodium borate is a non-Newtonian fluid i.e., unlike Newtonian fluids whose viscosity remains unchanged when strain is applied, the viscosity of borated PVOH increases with applied temperature and pressure. More specifically, borated PVOH is a dilatant; under stress it undergoes shear thickening, and the material dilates/expands. Other examples in this class of materials are quicksand, printer's ink, and starch solutions. As shown in FIG. 1, for the production of multi-ply fibrous structures alkaline salts of borates cannot be blended with poly vinyl alcohol due to immediate cross linking and gel formation which prevents application and causes process hygiene issues.

### Fibrous Structure

The fibrous structure of the present invention may comprise a single-ply web (a single fibrous structure ply) or multi-ply web (two or more and/or three or more fibrous structure plies that may be adhesively bonded together, for example via plybond glue, and/or mechanically bonded together, for example via a knurling wheel. The webs and/or fibrous structures of the present invention are made from a plurality of pulp fibers, for example wood pulp fibers and/or other cellulosic pulp fibers, for example trichomes. In addition to the pulp fibers, the webs and/or fibrous structures of the present invention may comprise synthetic fibers and/or filaments. The fibrous structure may be in roll form.

The fibrous structure, for example toilet tissue product, may exhibit a sum of MD and CD dry tensile (total dry tensile) of less than 1000 g/in and/or less than 900 g/in and/or less than 800 g/in and/or less than 750 g/in and/or less than 700 g/in and/or less than 650 g/in and/or less than 600 g/in and/or less than 550 g/in and/or greater than 250 g/in and/or greater than 300 g/in and/or greater than 350 g/in and/or less than 1000 g/in to about 250 g/in and/or less than 900 g/in to about 300 g/in and/or less than 800 g/in to about 400 g/in as measured according to the respective Dry Tensile Strength Test Method described herein.

The fibrous structure, for example paper towel product, may exhibit a sum of MD and CD dry tensile of greater than 1500 g/in and/or greater than 1750 g/in and/or greater than 2000 g/in and/or greater than 2100 g/in and/or greater than 2200 g/in and/or greater than 2300 g/in and/or greater than 2400 g/in and/or greater than 2500 g/in and/or less than 5000 g/in and/or less than 4000 g/in and/or less than 3500 g/in and/or greater than 1500 g/in to about 5000 g/in and/or greater than 1750 g/in to about 4000 g/in and/or greater than 1750 g/in to about 3500 g/in as measured according to the respective Dry Tensile Strength Test Method described herein.

The fibrous structures (e.g., toilet tissue products) of the present invention may exhibit a geometric mean peak elongation of greater than 10%, and/or greater than 15%, and/or greater than 20%, and/or greater than 25%, as measured according to the respective Dry Tensile Strength Test Method described herein.

The fibrous structures (e.g., toilet tissue products) of the present invention may exhibit a geometric mean dry tensile strength of greater than about 200 g/in, and/or greater than about 250 g/in, and/or greater than about 300 g/in, and/or greater than about 350 g/in, and/or greater than about 400 g/in, and/or greater than about 500 g/in, and/or greater than about 750 g/in, as measured according to the respective Dry Tensile Strength Test Method described herein.

The fibrous structures (e.g., toilet tissue products) of the present invention may exhibit a geometric mean modulus (at 15 g/cm) of less than about 20,000 g/cm, and/or less than about 15,000 g/cm, and/or less than about 10,000 g/cm, and/or less than about 5,000 g/cm, and/or less than about 3,000 g/cm, and/or less than about 1,500 g/cm, and/or less than about 1,200 g/cm, and/or between about 1,200 g/cm and about 0 g/cm, and/or between about 1,200 g/cm and about 700 g/cm, as measured according to the respective Dry Tensile Strength Test Method described herein.

The fibrous structures (e.g., toilet tissue products) of the present invention may exhibit a CD elongation of greater than about 8%, and/or greater than about 10%, and/or greater than about 12%, and/or greater than about 15%, and/or greater than about 20%, as measured according to the respective Dry Tensile Strength Test Method described herein. Further, the fibrous structures (e.g., toilet tissue products) of the present invention may exhibit a CD elongation of from about 8% to about 20%, or from about 10% to about 20%, or from about 10% to about 15%, as measured according to the respective Dry Tensile Strength Test Method described herein.

The fibrous structures (e.g., toilet tissue products) of the present invention may exhibit a dry burst of less than about 660 g, and/or from about 100 g to about 600 g, as measured according to the Dry Burst Test Method described herein. In another example, the fibrous structures (e.g., toilet tissue products) of the present invention may exhibit a dry burst of greater than about 100 g, and/or from about 100 g to about 1000 g, and/or from about 100 g to about 600 g, as measured according to the Dry Burst Test Method described herein.

The paper towel products of the present invention may exhibit a wet burst strength of greater than about 270 g, in another form from about 290 g and/or from about 300 g and/or from about 315 g to about 360 g and/or to about 380 g and/or to about 400 g as measured according to the Wet Burst Test Method described herein.

The toilet tissue products of the present invention may exhibit an initial total wet tensile strength of less than about 78 g/cm (200 g/in) and/or less than about 59 g/cm (150 g/in) and/or less than about 39 g/cm (100 g/in) and/or less than about 29 g/cm (75 g/in) and/or less than about 23 g/cm (60 g/in) and/or less than about 20 g/cm (50 g/in) and/or about less than about 16 g/cm (40 g/in) as measured according to the Wet Tensile Test Method described herein. In addition, the paper towel products of the present invention may exhibit an initial total wet tensile strength (“ITWT”) of greater than about 118 g/cm (300 g/in) and/or greater than about 157 g/cm (400 g/in) and/or greater than about 196 g/cm (500 g/in) and/or greater than about 236 g/cm (600 g/in) and/or greater than about 276 g/cm (700 g/in) and/or greater than about 315 g/cm (800 g/in) and/or greater than about 354 g/cm (900 g/in) and/or greater than about 394 g/cm (1000 g/in) and/or from about 118 g/cm (300 g/in) to about 1968 g/cm (5000 g/in) and/or from about 157 g/cm (400 g/in) to about 1181 g/cm (3000 g/in) and/or from about 196 g/cm (500 g/in) to about 984 g/cm (2500 g/in) and/or from about 196 g/cm (500 g/in) to about 787 g/cm (2000 g/in) and/or from about 196 g/cm (500 g/in) to about 591 g/cm (1500 g/in) as measured according to the Wet Tensile Test Method described herein.

Furthermore, the paper towel products of present invention may exhibit an initial total wet tensile strength of less than about 800 g/25.4 mm and/or less than about 600 g/25.4 mm and/or less than about 450 g/25.4 mm and/or less than about 300 g/25.4 mm and/or less than about 225 g/25.4 mm as measured according to the Wet Tensile Test Method described herein.

The toilet tissue products of the present invention may exhibit a decayed initial total wet tensile strength at 30 minutes of less than about 39 g/cm (100 g/in) and/or less than about 30 g/cm (75 g/in) and/or less than about 20 g/cm (50 g/in) and/or less than about 16 g/cm (40 g/in) and/or less than about 12 g/cm (30 g/in) and/or less than about 8 g/cm (20 g/in) and/or less than about 4 g/cm (10 g/in) as measured according to the Wet Tensile Test Method described herein.

The fibrous structures and/or webs of the present invention may exhibit a caliper of from about 5 mils to about 50 mils and/or from about 7 mils to about 45 mils and/or from about 10 mils to about 40 mils and/or from about 12 mils to about 30 mils and/or from about 15 mils to about 28 mils as measured according to the Caliper Test Method described herein.

The web may comprise a structured web, for example a web comprising at least one 3D patterned fibrous structure ply, for example a through-air-dried web, such as a creped through-air-dried fibrous structure ply and/or an uncreped through-air-dried fibrous structure ply.

The web may comprise a creped fibrous structure ply, for example a fabric creped fibrous structure ply and/or a belt creped fibrous structure ply and/or a conventional wet pressed fibrous structure ply.

The web may comprise through-air-dried (creped or uncreped) fibrous structures, belt creped fibrous structures, fabric creped fibrous structures, other structured fibrous structures such as NTT fibrous structures and ATMOS fibrous structures, conventional wet pressed fibrous structures, or mixtures thereof.

The web may comprise an embossed fibrous structure ply.

The web may be a wet-laid web and/or an air-laid web.

The webs and/or fibrous structures of the present invention may comprise a surface softening agent or be void of a surface softening agent. In one example, the fibrous structure is a non-lotioned fibrous structure, such as a fibrous structure comprising a non-lotioned fibrous structure ply, for example a non-lotioned through-air-dried fibrous structure ply, for example a non-lotioned creped through-air-dried fibrous structure ply and/or a non-lotioned uncreped through-air-dried fibrous structure ply. In yet another example, the fibrous structure may comprise a non-lotioned fabric creped fibrous structure ply and/or a non-lotioned belt creped fibrous structure ply.

The webs and/or fibrous structures of the present invention may comprise trichome fibers and/or may be void of trichome fibers.

### Non-Limiting Example of Method for Making a Fibrous Structure

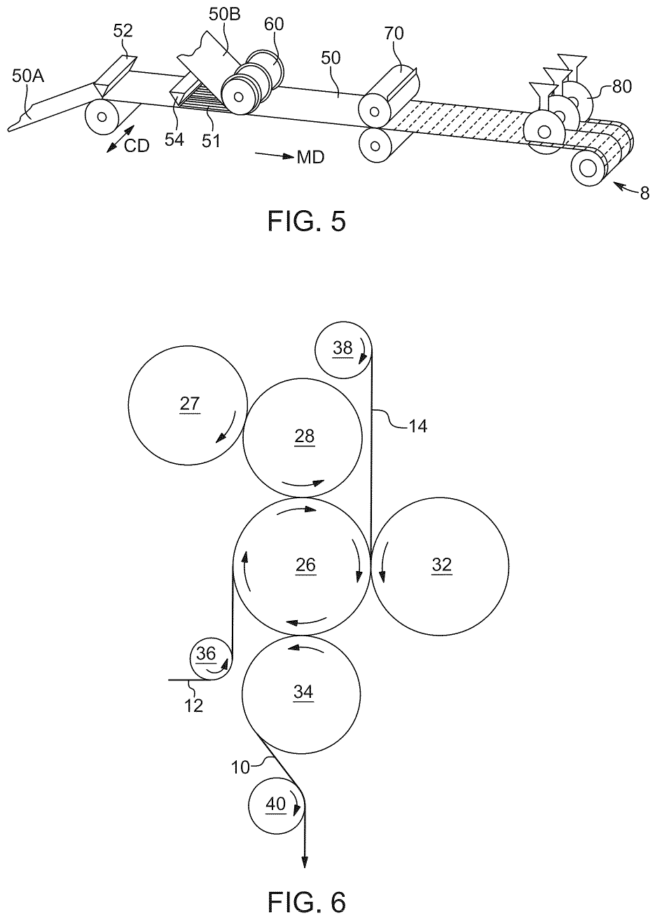

Referring to FIG. 5, showing one exemplary process according to the present invention, the substrate 50 comprises a laminate formed by two plies 50A and 50B. Both plies 50A and 50B are transported in the machine direction. An adhesive composition according to the present invention may be applied to one of the plies 50A, 50B by a glue applicator 52, 54, so that the plies 50A, 50B can be consequently joined together.

During the process, the adhesive composition 51 is deposited onto the ply 50A by a glue applicator 52, 54. The glue applicator 52, 54 is preferably structured to provide a plurality of individual stripes of the adhesive composition and may comprise an extrusion apparatus. As an example, one preferred type of the extrusion apparatus is DuraFiber® 15-20 Pressure Fed Manifold, commercially available from J&M Laboratories of Dawsonville, Ga. 30534.

As the ply 50A travels in the machine direction MD, the glue applicator 52, 54 is moving, preferably reciprocally, in the cross-machine direction CD. The resulting stripes of the adhesive composition 51 deposited onto the ply 50A have a waving, or “sinusoidal,” configuration defined by the velocity of the web, and the amplitude and velocity of the glue applicator 52, 54.

Then, the plies 50A, 50B are joined together at a combining roll 60 such that the adhesive composition 51 is interposed between the two plies 50A, 50B. The laminate may further be perforated by a perforator 70, slit into individual sheets by slitters 80, and wound into the roll 8, as well known by those skilled in the art.

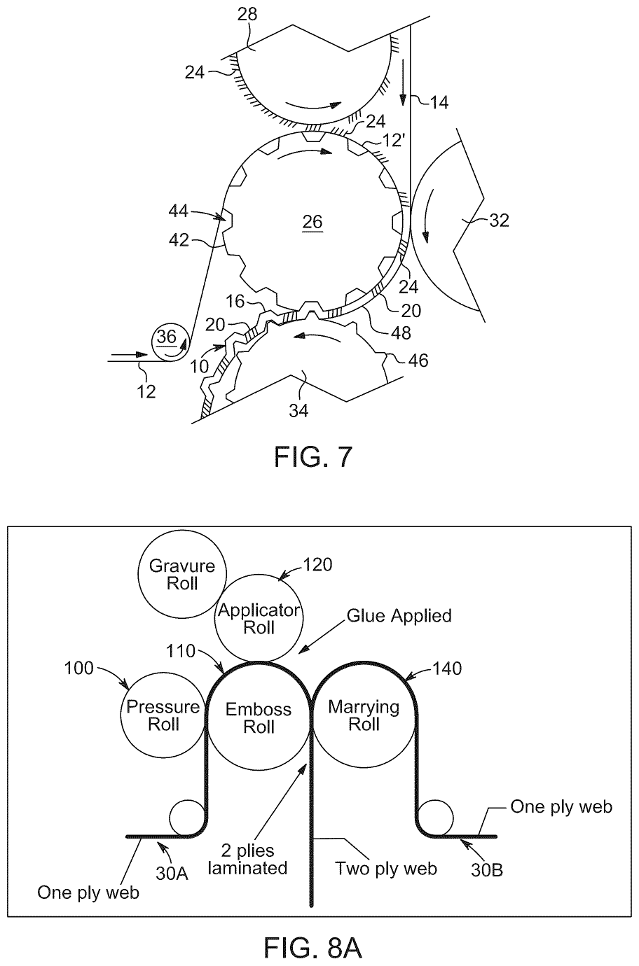

In an embodiment, as shown in FIGS. 6 and 7, a first ply of fibrous structure 12 contacts knob surfaces 42 of a first embossing roll 26, such as an engraved steel embossing roll. An applicator roll 28 for applying an adhesive composition according to the present invention 24 applies the adhesive 24 composition to the ply 12 where the ply 12 is supported by the knob surfaces 42. The adhesive composition 24 may be applied to the ply 12 in a pattern of discrete dots to produce an adhesive composition-containing ply 12′ as shown in FIG. 7. The adhesive composition 24 may be applied to the applicator roll 28 by a gravure system, preferably an offset gravure system comprising a gravure roll 27. The gravure system can meter a specified amount of adhesive composition 24 from an adhesive pan onto the applicator roll 28. Other suitable means of applying the adhesive composition 24 are known to those of ordinary skill in the art.

The first ply 12 may be under tension suitable for controlling the first ply at some point during its contact with the first embossing roll 26.

A second ply 14 is brought into contact with the adhesive composition 24 present on the first ply 12′ at a nip between the first embossing roll 26 and a marrying roll 32. The first ply and second ply are bonded together (i.e., combined) into a multi-ply fibrous structure 48. The marrying roll 32 may be a solid marrying roll, i.e., smooth surface marrying roll.

The marrying roll 32 applies pressure to the multi-ply fibrous structure 48 and the adhesive composition 24 is pressed between the two plies at the bond sites 20 where the first ply 12′ is supported by knob surfaces 42. This action bonds the two plies together and produces a plybond strength of at least about 4 g/in. At this point, the multi-ply fibrous structure 48 has not yet been embossed.

Next, the multi-ply fibrous structure 48 enters the interface between the first embossing roll 26 with its depressions 44 and a second embossing roll 34 with its protuberances 46. The second embossing roll 34 may be a steel embossing roll. The protuberances 46 of the second embossing roll 34 and the depressions 44 of the first embossing roll 26 are aligned such that the protuberances 46 nest within the depressions 44. The protuberances 46 are engaged into the depressions 44 at a length of at least about 50 mils such that an embossed height of at least 1000 μm is formed in the multi-ply fibrous structure 48. The embossed multi-ply fibrous structure 10 product exits the nip between the first embossing roll 26 and the second embossing roll 34.

The bond sites 20 are densified at the nip between the first embossing roll 26 and the marrying roll 32 and/or at the interface between the first embossing roll 26 and the second embossing roll 34.

The embossment sites 16 which result from the protuberances 46 of the second embossing roll 34 engaging the depressions 44 of the first embossing roll 26 are non-densified.

Web handling rolls 36, 38 and 40 may be used to control and/or advance the fibrous structures 12 and 14 and/or multi-ply fibrous structure product 10.

Preferred rotational direction of the rolls used in this method are represented by arrows associated with the rolls.

It is desirable that rolls 26, 28, 32 and 34 run at the same speed. Web handling rolls 36, 38 and 40 do not have to run at the same speed as rolls 26, 28, 32 and 34.

Preferred machine direction of the fibrous structures 12 and 14 and/or multi-ply fibrous structure product 10 are represented by arrows associated with the fibrous structures 12 and 14 and/or multi-ply fibrous structure product 10.

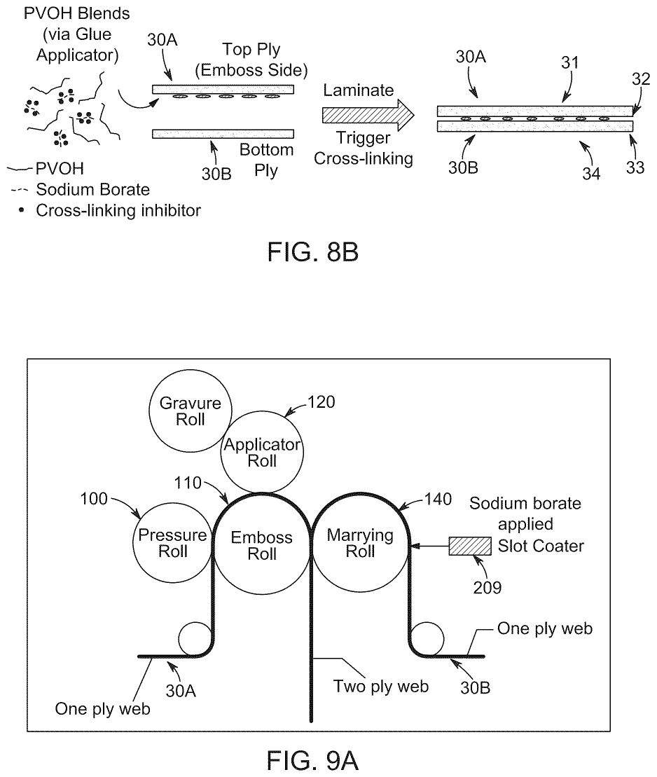

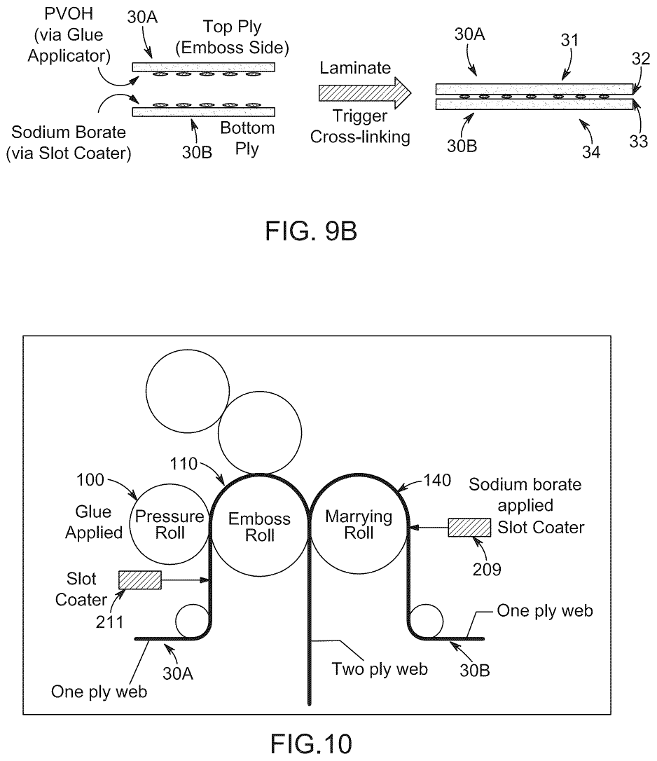

Further embodiments of producing fibrous structures, such as those described above, exemplify methods of applying the adhesive compositions of the present invention as shown in FIGS. 8A-10. As shown in FIGS. 8A and 8B a roll adhesive application system can be used to apply the adhesive composition. Using this system, a first ply 30A having a first surface 31 and a second surface 32 enters the application system feeding between pressure roll 100 and embossment roll 110 where it travels across the surface of the embossment roll 110 in the direction of the applicator roll 120. Adhesive composition is picked up as a film on the surface of the applicator roll 120. The adhesive composition on the applicator roll 120 is applied on the embossments of the first ply 30A. The embossments of the first ply 30A are then brought in contact with a second ply 30B having a first surface 33 and a second surface 34 entering the application from the surface of a marrying roll 140. The plies area adhesively joined together in the nip of the marrying roll 140. In another embodiment, as shown in FIGS. 9A and 9B, using the same application system described for FIGS. 8A and 8B, the adhesive composition is applied to the plies in separate applications. As described above PVOH is applied to the first ply 30A using an applicator roll 120. Sodium borate, and in embodiments a cross-linking inhibitor, is applied with a slot coater 209 to a second ply 30B. The sodium borate is supplied to the slot coater 209 with a progressive cavity pump. A mass meter and variable speed pump motor are used to control fluid flow. The slot coater 209 is an infinite cavity design, and the shimmed slot is sized to keep slot coat pressure in a range from approximately 1 to approximately 80 psi. Of course, the adhesive may be applied in any other manner as well known in the art and is commonly used for nested or knob-to-knob embossing processes as well. Suitable adhesive application systems include gravure systems, spray systems, flexographic systems as well as the roll system described above.

In another embodiment as shown in FIG. 10 the PVOH and sodium borate may be applied to a first ply 30A having a first surface 31 and a second surface 32 and a second ply 30B having a first surface 33 and a second surface 34 using separate slot coaters 209, 211.

### Test Methods

### Dry Plybond Test Method for Towel:

This test method measures the dry plybond strength between two adjacent plies of the fibrous structure using a tensile testing machine and calculates results in units of grams (force) per inch of sample width, based on the average of four test samples.

The instrument used in this method is a constant rate of extension tensile tester with computer interface (a suitable instrument is the EJA Vantage and MAP4 software from the Thwing-Albert Instrument Co. West Berlin, NJ) using a suitably sized load cell (in the range of 10-50 Newton maximum force capability) and with pneumatic 3 inch wide grips with adequate air pressure to prevent sample slippage during testing.

Condition the samples or useable units of product, with wrapper or packaging materials removed, in a room conditioned at 50±2% relative humidity and 23° C.±1° C. (73°±2° F.) for a minimum of ten minutes prior to testing. Do not test useable units with perforations, or defects such as wrinkles, tears, holes, effects of tail seal or core adhesive, etc., and when necessary, replace with other useable units free of such defects. For each sample, four usable units are used for testing. Using a precision cutter (such as Thwing-Albert JDC 3″ model), cut a three-inch wide strip from the center of each of the four of the usable units with their long dimension in the CD (cross direction). All four prepared test strips shall have a width of 3.00 inch (+/−0.05 in) and a length between 6.75 and 11.5 inches, depending on the dimensions of the uncut usable unit. Place a small mark (with a pencil or marker) on one end of each strip, such that two strips have marks on opposite sides of the other two strips (this is done so that the plybond test is initiated from both sides of the product sample usable unit).

On one end of each of the test strips with a mark showing, carefully separate 1.5-2.0 inches the top ply from the bottom ply (minimizing tearing as much as practically possible). If the test strip has more than two plies, separate the 1 or more plies together from the other 1 or more plies together, and record in the final test results the exact position from the top surface (top meaning the side of the paper that typically faces the consumer in the finished product form).

Set the gauge length (i.e., the distance between grips) to 2.0 inches. This position is defined as the ‘home’ position (zero). With nothing inside the grips, zero the load cell to read 0 grams force (+/−0.5 grams). Insert top-side ply into the open upper grip, with the length of the paper strip extending out towards the analyst (i.e., not towards the instrument), then close the grip. Insert the other ply into the open bottom grip, then close this grip.

The test script (in MAP4 software) is initiated, with the following programmed settings:

$$Test Speed ( upward ) = 20 in / min$$

$$Total Crosshead Travel Distance = 7.5 inches$$

$$Data acquisition rate = 20 pts / sec$$

The test collects force (gr) and crosshead position (in) for the entire 7.5 inches of upward crosshead movement, as the plies are separated, after which it stops collecting data and returns to the original (home) starting position. During testing, the test strip must not be touched by the analyst in any way, as this could alter the measured force on the load cell.

The array of position and force data is analyzed as follows: The starting (home) position is defined at 0 inches, and at each position (in) thereafter is a corresponding force value (g_{f}). All force values between positions 1.50 inch and 7.50 inch (or more precisely, starting with 1.50 inch data point (or the very next data point after crossing this value) through the 7.50 inch data point (or the very next data point after crossing this value) are averaged and divided by the sample width (3 inches) in order to calculate a dry plybond strength (gr/in) for this first test strip. The second test strip replicate is tested in the exact same manner, and so on, until all four test strips are tested. These four test results are averaged to produce the reported number for the sample: “Dry plybond strength” (g_{f}/in), reported to the nearest 0.1 g_{f}/in.

If the test strip becomes completely separated before the crosshead has travelled the full 7.5 inches, which could occur if the test strip is between 5.75 and 6.75 inches long, then the instrument testing script may be modified to accommodate the shorter test strip length, albeit at the cost of less peel force data included in the calculation. The shortest strip length allowable is 4.0 inches. Based on the test strip length between 4 and 5.75 inches, the instrument programming script can be modified as follows:

$$Modified Total Crosshead Travel Distance = [ 7.5 - 2 * ( 5.75 - test strip length ) ] inches$$

Furthermore, the range of force values used in this modified set-up calculation are also modified to be between positions 1.50 inch and [7.50−2*(5.75−test strip length)] inches [or more precisely, starting with 1.50 inch data point (or the very next data point after crossing this value) through the [7.50−2*(5.75−test strip length)] inch data point (or the very next data point after crossing this value)}. To reiterate, these modifications are only used when the minimum 6.75 inch length test strip cannot be created from the sample in the CD.

### Wet 90 Degree Plybond Test Method:

This test method measures the wet 90 degree plybond peel strength of a multi-ply paper towel, using a 90 degree peel test apparatus, and calculates results in units of grams (force) per inch of sample width, based on the average of two test samples.

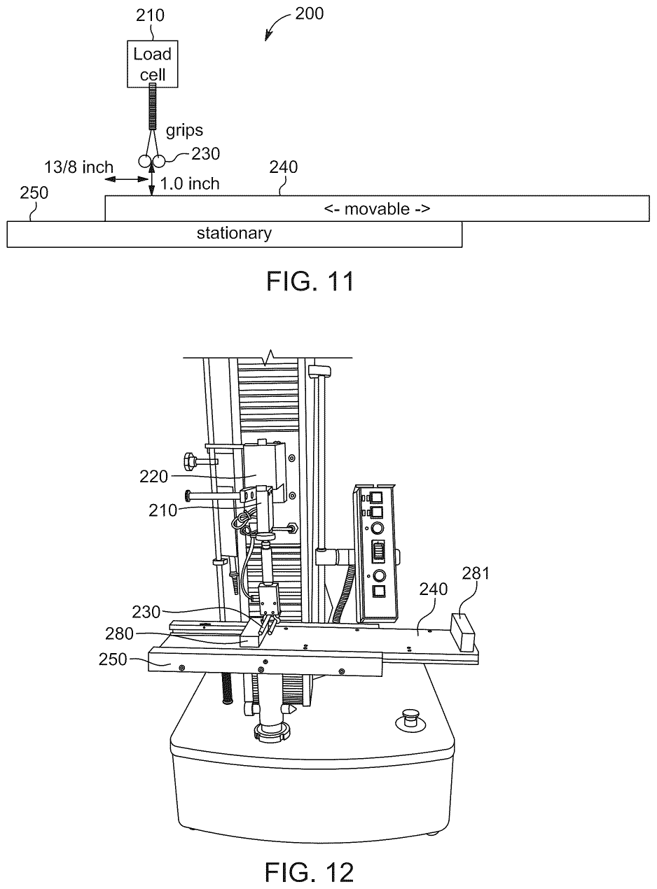

As shown in FIGS. 11-13, the instrument used in this method is a constant rate of extension tensile tester with computer interface 200 (a suitable instrument is the EJA Vantage and MAP4 software from the Thwing-Albert Instrument Co. West Berlin, NJ) using a suitably sized load cell 210 (in the range of 10-50 Newton maximum force capability) equipped with a 90 degree peel fixture (Thwing-Albert part #1750-3005). This particular peel fixture is equipped with a string that connects its horizontal movement to the vertical movement of the upper arm 220 (i.e., crosshead) of the tensile tester 200. Also attached to this upper arm 220 is the aforementioned load cell 210, and to this is fitted with pneumatic 3 inch wide grips 230 with adequate air pressure to prevent sample slippage during testing.

The bottom edge of the grip 230 (i.e., the lowest position where the sample is secured inside the grip) is positioned 1.0 inch from the surface of the movable platform 240, which slidably nests on the surface of the stationary platform 250. The left edge of this movable surface 240 is positioned 1⅜ inches to the left (facing) side of a perpendicular plane of closed upper grip centerline (see schematic drawing below). This position is defined as the ‘home’ position (zero). With nothing inside the grip, zero the load cell to read 0 grams force (+/−0.5 grams).

Condition the samples or useable units of product, with wrapper or packaging materials removed, in a room conditioned at 50±2% relative humidity and 23° C.±1° C. (73°+2° F.) for a minimum of ten minutes prior to testing. Do not test useable units with perforations, or defects such as wrinkles, tears, holes, effects of tail seal or core adhesive, etc., and when necessary, replace with other useable units free of such defects. For each sample, two test strips are prepared using a precision cutter (such as Thwing-Albert JDC 3″ model) into dimensions of 11 inches (+/−0.25 in) parallel to the CD, and a width of 3.00 inch (+/−0.05 in) parallel to the MD.

On one end of the test strip 270, carefully separate 1.5-2.0 inches the top ply 271 from the bottom ply 272 (minimizing tearing as much as practically possible). If the test strip 270 has more than two plies, separate the 1 or more plies together from the other 1 or more plies together, and record in the final test results the exact position from the top surface (top meaning the side of the paper that typically faces the consumer in the finished product form).

Insert top-side ply 271 into the open grip 230 and align the edge of the bottom-side ply 272 to the end of the movable platform edge (+/−1 mm from platform edge), while also maintaining alignment of the test strip 270 along length of the platform movable surface 240.

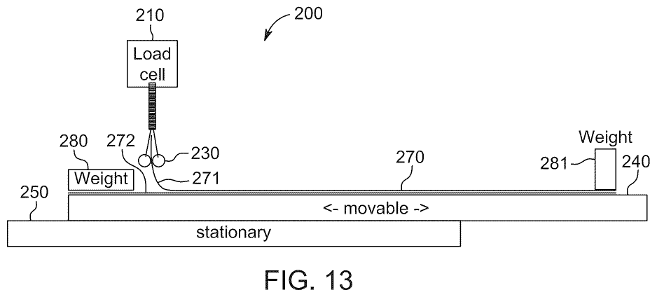

Copper bar weights 280, 281 are used to hold the test strip 270 in place (0.625″×1.0″×3.0″, each weighing about 274 g). Place one of the brass weights 280 on the test strip 270 on the left side (wider side of weight facing down) under the grip 230 (not touching the grip) and aligned such that both test strip 270 and weight 280 edges area aligned with platform edge+/−1 mm. Place the other brass weight 281 on the right side of the test strip 270 (with its narrow side facing down) aligned with the test strip's 270 right edge+/−1 mm. Verify test strip top ply 271 is inside grip, then close the grip 230. See schematic drawing of FIG. 13, which shows the initial set-up with test strip 270 installed.

Using a plastic squeeze wash water bottle with dispensing nozzle (Sigma-Aldrich part Z423335, or similar) filled with deionized (DI) water at 23 (+/−) degrees C., squirt water onto test strip 270, starting on the left side (near the grip, but not wetting the grip itself) saturating the entire paper test strip between the grip 230 and the weight on the right side 272. Uniformly distribute enough water such that the test strip 270 is visibly saturated, without significant amounts of water pooling outside the test strip 270 itself. The water addition level must not be below 10 grams of water per gram of dry (unwetted) paper, with an ideal addition level typically about 13-15 g/g for most paper towel samples to achieve full saturation for this test. Between 15-25 seconds after the start of the initial wetting process, the test script (in Map4 software) is initiated, with the following programmed settings:

$$Test Speed ( upward ) = 20 in / min$$

$$Total Crosshead Travel Distance = 8.5 inches$$

$$Data acquisition rate = 20 pts / sec$$

$$Return Speed ( downward ) = 39 in / min$$

The test collects force (gr) and crosshead position (in) for the entire 8.5 inches of upward crosshead movement, as the plies are separated, after which it stops collecting data and returns to the original (home) starting position. This first array of position and force data will be referred to as “first-pull data array”. The sample strip, weights, and upper grip are left untouched, and the strip stays clamped . . . i.e., nothing is disturbed. Also, do not re-zero the load cell. Within 5 seconds after the crosshead has returned to the home position, the test script is initiated again. This second array of position and force data will be referred to as “second-pull data array”.

After this, the grip 230 is opened, weights 280, 281 are removed, and the wet test strip 270 is discarded. The test platform 240, 250 and grip 230 area are dried with disposable paper towels to remove all water before proceeding to the next test strip.

The two data arrays are analyzed as follows: The starting (home) position is defined at 0 inches, and at each position (in) thereafter is a corresponding force value (g_{f}). All force values between positions 1.50 inch and 7.50 inch (or more precisely, starting with 1.50 inch data point (or the very next data point after crossing this value) through the 7.50 inch data point (or the very next data point after crossing this value) are averaged in order to calculate an “average force value” from the “first-pull” (F_{avg, 1st}) and second pull (F_{avg, 2nd}). The wet plybond strength (g_{f}/in) for this first test strip is calculated by subtracting the second pull from the first, and then dividing by the width (in) of the test strip:

$$Wet 90 degree plybond strength ( {g}_{f} / in ) = ( {F}_{avg , 1 s t} - {F}_{avg , 2 nd} ) / 3 in$$

The second test strip replicate is tested in the exact same manner, in order to produce two such values, which are averaged to produce the reported number for the sample: “Wet 90 degree plybond strength” (g_{f}/in), reported to the nearest 0.01 g_{f}/in.

In the unlikely case that if, during testing, the copper weights are unable to hold the test strip secure (i.e., the wetted test strip sliding under one or both weights as the plies are being separated), then it is necessary to add more downward force on the weights to prevent such movement. This may occur when ply bonding forces are high, exceeding the ability of the copper weights to hold the sample ends secure.

Also, if the test sample has dimensions such that is impossible to create test strip of the proper length in the CD (11 inches), then the instrument testing script may be modified to accommodate the shorter length, albeit at the cost of less peel force data included in the calculation. The shortest strip length allowable is 7.0 inches. Based on the test strip length between 7 and 11 inches, the instrument programming script can be modified as follows:

$$Modified Total Crosshead Travel Distance = [ 8.5 - ( 11 - test strip length ) ] inches$$

Furthermore, the range of force values used in this modified set-up calculation are also modified to be between positions 1.50 inch and [7.50−(11−test strip length)] inches (or more precisely, starting with 1.50 inch data point (or the very next data point after crossing this value) through the [7.50−(11−test strip length)] inch data point (or the very next data point after crossing this value). To reiterate, these modifications are only used when 11″ length (in CD) test strip cannot be created from the sample.

### Viscosity Test Method

The Viscosity Method uses a rotational rheometer with a suitable geometry to measure the viscosity of a sample at 70.0±0.1° C. and 100 s−1.

A suitable apparatus for this method is a controlled-stress rotational rheometer capable of maintaining a sample temperature of 70.0±0.1° C., an example of which is the Discovery HR-2 rheometer outfitted with temperature controller available from TA Instruments, New Castle, Delaware, or equivalent. The rheometer tooling is selected based on the apparent viscosity of the sample.

For less viscous samples, such as a 5% PVOH solution, the rheometer is outfitted with Couette “concentric cylinders” tooling with a stainless-steel cup (30 mm diameter by 78 mm depth, such as TA part 545696.901, or equivalent) and stainless-steel rotor (28 mm diameter by 42 mm height, such as TA part 546012.901, or equivalent).

With the rheometer tooling held at 70° C., 24±1.5 mL of the sample is poured into the stainless-steel rheometer cup. The upper rotor is lowered to an operating gap of 5919.2 μm and a two-piece cup cover is placed on top of the sample cup around the rotor's shaft. The sample is conditioned at 70° C. for at least five minutes until a steady temperature of 70±0.1° C. is achieved and subsequently held at 70±0.1° C. for the entire method. Viscosity is measured using a flow peak hold at 100 s−1 for 60 seconds, collecting one point per second. The average viscosity at 70±0.1° C. and 100 s−1 is calculated by averaging the data points collected for seconds 30-60 of the run and reporting the average viscosity to the nearest 1 cP.

For samples with a higher viscosity, such as specified in the Comparative and Inventive Examples, a 20 mm stainless steel Peltier parallel plate geometry (TA part 511200.946 or equivalent) was used as an upper tooling with a Peltier plate (TA part 533209.901 or equivalent) mounted on the bottom of the rheometer. With the Peltier plate held at 70° C., approximately 1 mL of the sample is placed onto the Peltier plate under the parallel plate tooling. The upper tooling is lowered to a trim gap of 1550 μm. The excess sample is trimmed from around the geometry using a plastic spatula. The upper tooling is then lowered to the operating gap of 1500 μm and a two-piece cup cover is placed on top of the parallel plate geometry around the rotor's shaft. The sample is conditioned at 70° C. for at least five minutes until a steady temperature of 70±0.1° C. is achieved and subsequently held at 70±0.1° C. for the entire method. Viscosity is measured using a flow peak hold at 1 s−1 for 60 seconds, collecting one point per second. The average viscosity at 70±0.1° C. and 1 s−1 is calculated by averaging the data points collected for seconds 30-60 of the run and reporting the average viscosity to the nearest 1 cP.

### EXAMPLES

TABLE 1

| | Inv | Inv Ex | Inv Ex | Inv Ex | Inv Ex | Inv Ex | Inv Ex | Inv Ex |
|---|---|---|---|---|---|---|---|---|
| | Ex 1A | 1B | 1C | 1D | 2C | 2D | 3D | 4D |
| Ingredients | (wt %) | (wt %) | (wt %) | (wt %) | (wt %) | (wt %) | (wt %) | (wt %) |
| Polyvinyl | 10 | | | 5 | | 5 | 3.5 | 3.5 |
| Alcohol | | | | | | | | |
| Boric acid | | 6.37 | | | | | | |
| Sodium | | 1.03 | | | | | | |
| Hydroxide | | | | | | | | |
| 1,2-hexanediol | | | 5.83 | | | | | |
| Glycerol | | | | | 5.90 | | | |
| Sodium Borate | | | 6.96 | | 6.96 | | | |
| Sodium Borate | | | | 0.33 | | 0.33 | 0.23 | |
| and | | | | | | | | |
| 1,2-hexanediol | | | | | | | | |
| Blend | | | | | | | | |
| Sodium Borate | | | | | | | | 0.23 |
| and | | | | | | | | |
| Glycerol Blend | | | | | | | | |
| Fluorescent | | 0.004 | | | | | | |
| Agent | | | | | | | | |
| Water | 90 | 92.60 | 87.2 | 94.67 | 87.13 | 94.67 | 96.27 | 96.27 |
| P1 | — | — | — | 15:1 | — | 15:1 | 15:1 | 15:1 |
| (PVOH/Sodium | | | | | | | | |
| borate + cross- | | | | | | | | |
| linking inhibitor | | | | | | | | |
| ratio) | | | | | | | | |
| P2 (Sodium | — | — | — | 1.2:1 | — | 1.2:1 | 1.2:1 | 1.2:1 |
| borate to cross- | | | | | | | | |
| linking inhibitor | | | | | | | | |
| ratio) | | | | | | | | |

TABLE 2

| | Comp | Comp | Comp | Comp | Comp | Comp |
|---|---|---|---|---|---|---|
| | Ex 1 | Ex 2 | Ex 3 | Ex 4 | Ex 6 | Ex. 7 |
| Ingredients | (wt %) | (wt %) | (wt %) | (wt %) | (wt %) | (wt %) |
| Polyvinyl Alcohol | 5 | 5 | 5 | 5 | 5 | 5 |
| Boric acid | | | 1.25 | 0.17 | | |
| Sodium Borate | 1.25 | 0.625 | | | | |
| Sodium Borate and | | | | | 1.25 | |
| 1,2-hexanediol Blend | | | | | | |
| PAE* resin (Kymene | | | | | | 1.25 |
| 5221) | | | | | | |
| Water | 93.75 | 94.375 | 93.75 | 94.83 | 93.75 | 93.75 |
| P1 (PVOH/Sodium borate + | — | — | — | — | 4:1 | — |
| cross-linking inhibitor | | | | | | |
| ratio) | | | | | | |
| P2 (Sodium borate to | — | — | — | — | 1:2:1 | — |
| cross-linking inhibitor | | | | | | |
| ratio) | | | | | | |

*Polyamidoamineepichlorohydrin

### Inventive Example 1

This example demonstrates that polyvinyl alcohol can be blended with alkaline sodium borate with the aid of 1,2-hexanediol used as a cross-linking inhibitor at a given PVOH/sodium borate+1,2-hexanediol ratio of P1=15:1 and sodium borate/1,2-hexanediol ratio of P2=1.2:1 with 5% PVOH as shown in TABLE 1.

1 kg quantity of a blend of 5% polyvinyl alcohol with alkaline sodium borate and 1,2-hexanediol mixture provided in TABLE 1 was prepared as follows.

### Step 1A. Preparation of 1 kg 10% Active Polyvinyl Alcohol Solution

100 g of polyvinyl alcohol powder Elvanol 71-30 (100% active/Kuraray) was dissolved in 900 g of deionized water using an overhead mixer equipped with an impeller. The batch making was conducted in a stainless steel vessel. The material was first dispersed/mixed in water at ˜25° C. for about 15 minutes to fully hydrate it, then the temperature in the vessel was increased to approximately 90° C., and the mixture was stirred for about 30 minutes until clear solution was obtained.

### Step 1B. Preparation of 1 kg 7.4% Active Alkaline Sodium Borate Solution

63.7 g boric acid powder (100% active/Three Elephants) and 0.04 g of Tinopal CBS-x fluorescent agent (100% active/BASF) were dissolved in 915.7 g deionized water using an overhead mixer equipped with an impeller at ˜25° C. Finally 20.55 g 50% sodium hydroxide solution (BDH/VWR) was added to make the alkaline sodium borate solution with PH˜9.

Step 1C. Preparation of 1 kg˜12.9% active sodium borate and 1,2-hexanediol mixture (sodium borate to 1,2-hexanediol weight ratio˜1.2)

58.9 g of 1,2-hexanediol (99% active, Hydrolite-6/Symrise Inc., Elyria, OH) was directly dissolved into 941.1 g of 7.4% active sodium borate solution (prepared in Step 2, as described above with reference to Inventive Ex 1) using an overhead mixer equipped with an impeller to make the 12.8% active mixture at ˜25 C.

Step 1D. Blending polyvinyl alcohol with sodium borate and 1,2-hexanediol mixture-PVOH to sodium borate+1,2-hexanediol ratio by weight 15

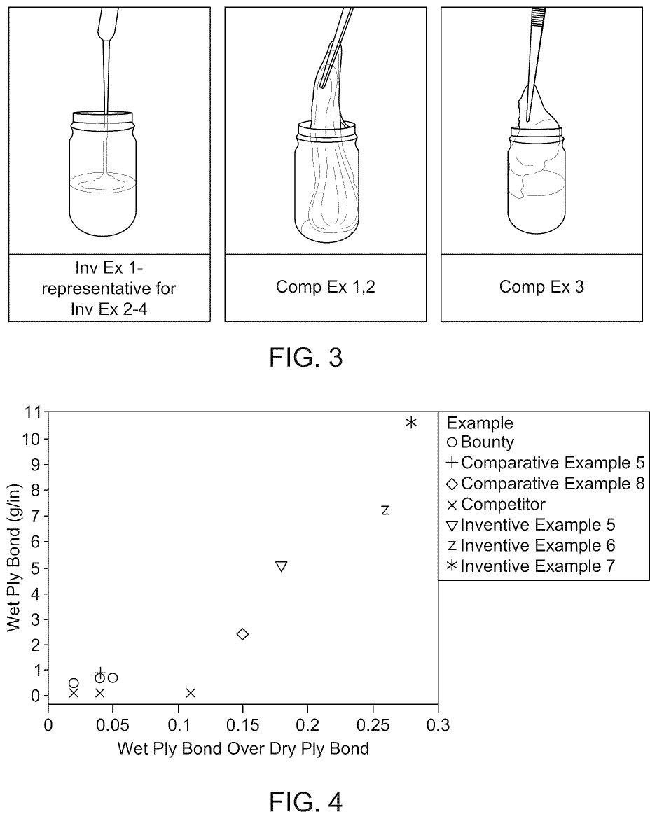

500 g 10% active PVOH solution (prepared in Step 1, as described above with reference to Inventive Example 1), was mixed with 473.9 g deionized water using an overhead mixer equipped with an impeller at ˜25° C. Added 26.04 g 12.8% active sodium borate+1,2-hexanediol mixture (Step 3) under stirring at ˜25° C. to make the final blend having desired viscosity (TABLE 4) and flow properties (FIG. 3)

### Inventive Example 2

This example demonstrates that polyvinyl alcohol can be blended with alkaline sodium borate with the aid of glycerol used as a cross-linking inhibitor at a given PVOH/sodium borate+glycerol ratio of P1=15:1 and sodium borate/1,2-hexanediol ratio of P2=1.2:1 with 5% PVOH as shown in TABLE 1.

1 kg quantity of a blend of 5% polyvinyl alcohol with alkaline sodium borate and glycerol mixture provided in TABLE 1 was prepared as follows.

### Steps 2A and 2B

10% active PVOH and 12.9% active sodium borate were prepared as described in Invention Ex. 1 (Step 1A-1B).

Step 2C. Preparation of 1 kg˜12.9% active sodium borate and glycerol mixture (sodium borate to glycerol weight ratio˜1.2)

59.0 g of glycerol (100% active, P&G Chemicals, Moon-Ou, USP, FCC) was directly dissolved into 941.1 g of 7.4% active sodium borate solution (prepared in Step 2, as described above with reference to Inventive Ex 1) using an overhead mixer equipped with an impeller to make the 12.9% active mixture at ˜25 C.

Step 2D. Blending polyvinyl alcohol with sodium borate and glycerol mixture-PVOH to sodium borate+glycerol ratio by weight 15

500 g 10% active PVOH solution (prepared in Step 1, as described above with reference to Inventive Example 1), was mixed with 474.1 g deionized water using an overhead mixer equipped with an impeller at ˜25° C. Added 25.90 g 12.9% active sodium borate+glycerol mixture (Step 3) under stirring at ˜25° C. to make the final blend having desired viscosity (TABLE 4) and flow properties (FIG. 3)

### Inventive Example 3

This example demonstrates that polyvinyl alcohol can be blended with alkaline sodium borate with the aid of 1,2-hexanediol used as a cross-linking inhibitor at a given PVOH/sodium borate+1,2-hexanediol ratio of P1=15:1, sodium borate/1,2-hexanediol ratio of P2=1.2:1 with 3.5% PVOH as shown in TABLE 1.

1 kg quantity of a blend of 3.5% polyvinyl alcohol with alkaline sodium borate and 1,2-hexanediol mixture provided in TABLE 1 was prepared as follows.

Steps 3A, 3B, and 3C: Preparation of 1 kg 10% active polyvinyl alcohol solution, 7.4% active alkaline sodium borate solution, and ˜12.9% active sodium borate and 1,2-hexanediol mixture.

10% active PVOH and 12.9% active sodium borate, and ˜12.9% active sodium borate and 1,2-hexanediol mixture were prepared as described in Invention Ex. 1 (Steps A-B, C)

Step 3D. Blending polyvinyl alcohol with sodium borate and 1,2-hexanediol mixture-PVOH to sodium borate+1,2-hexanediol ratio by weight 15

350 g 10% active PVOH solution (prepared in Step 1, as described above with reference to Inventive Example 1), was mixed with 631.8 g deionized water using an overhead mixer equipped with an impeller at ˜25° C. Added 18.2 g 12.8% active sodium borate+1,2-hexanediol mixture (Step 3) under stirring at ˜25° C. to make the final blend having desired viscosity (TABLE 4) and flow properties (FIG. 3)

### Inventive Example 4

This example demonstrates that polyvinyl alcohol can be blended with alkaline sodium borate with the aid of glycerol used as a cross-linking inhibitor at a given PVOH/sodium borate+glycerol ratio of P1=15:1 and sodium borate/1,2-hexanediol ratio of P2=1.2:1 as shown in TABLE 1.

1 kg quantity of a blend of 3.5% polyvinyl alcohol with alkaline sodium borate and glycerol mixture provided in TABLE 1 was prepared as follows.

Steps 4A, 4B, and 4C: Preparation of 1 kg 10% active polyvinyl alcohol solution, 7.4% active alkaline sodium borate solution, and ˜12.9% active sodium borate and glycerol mixture.

10% active PVOH and 12.9% active sodium borate, and ˜12.9% active sodium borate and 1,2-hexanediol mixture were prepared as described in Invention Ex. 1 (Steps A-B) and Inv Ex. 2 C

Step 3D. Blending polyvinyl alcohol with sodium borate and 1,2-hexanediol mixture-PVOH to sodium borate+glycerol ratio by weight 15

350 g 10% active PVOH solution (prepared in Step 1, as described above with reference to Inventive Example 1), was mixed with 631.9 g deionized water using an overhead mixer equipped with an impeller at ˜25° C. Added 18.1 g 12.8% active sodium borate+glycerol mixture (Step 3) under stirring at ˜25° C. to make the final blend having desired viscosity (TABLE 4) and flow properties (FIG. 3)

### Inventive Example 5

This example demonstrated that 2-ply product made using the adhesive disclosed in Inventive Example 1 delivered higher wet ply bond and higher wet ply bond/dry ply bond ratio versus Control 2-ply product made with polyvinyl alcohol, as shown in TABLE 3. A single application method using the glue applicator, as described above and shown in FIGS. 8A and 8B, was used for the application of inventive adhesive blend.

### Inventive Example 6

This example demonstrates that 2-ply product made using the adhesive composition disclosed in Inventive Example 2 delivered higher wet ply bond and higher wet ply bond/dry ply bond ratio versus Control 2-ply product made with polyvinyl alcohol. A single application method using the glue applicator, as described above and shown in FIGS. 8A and 8B, was used for the application of inventive adhesive blend.

### Inventive Example 7

This example demonstrated that 2-ply product made using the adhesive disclosed in Inventive Example 3 delivered higher wet ply bond and higher wet ply bond/dry ply bond ratio versus Control 2-ply product made with polyvinyl alcohol, as shown in TABLE 3. A single application method using the glue applicator, as described above and shown in FIGS. 8A and 8B, was used for the application of inventive adhesive blend.

### Inventive Example 8

This example demonstrates that 2-ply product made using the adhesive composition disclosed in Inventive Example 4 delivered higher wet ply bond and higher wet ply bond/dry ply bond ratio versus Control 2-ply product made with polyvinyl alcohol. A single application method using the glue applicator, as described above and shown in FIGS. 8A and 8B, was used for the application of inventive adhesive blend.

### Inventive Example 9

This example demonstrated that 2-ply product with basis weight of 36.4 lb/3000 ft2 made by separate application of PVOH adhesive and alkaline sodium borate cross-linker at approximately 81 mg/m2 add-on into the interior surfaces of each ply delivered higher wet ply bond and higher wet ply bond/dry ply bond ratio versus Control 2-ply product made with polyvinyl alcohol. Two application methods were used to apply PVOH adhesive and alkaline sodium borate cross linker, respectively. PVOH was applied using the glue applicator while alkaline sodium borate cross-linker was applied using slot coating into the interior of other ply prior to laminating 2 plies, as described above and shown in FIGS. 9A and 9B.

### Inventive Example 10

This example demonstrated that 2-ply product with basis weight of 36.4 lb/3000 ft2 made by separate application of PVOH adhesive and alkaline sodium borate cross-linker at approximately 163 mg/m2 add-on into the interior surfaces of each ply delivered higher wet ply bond and higher wet ply bond/dry ply bond ratio versus Control 2-ply product made with polyvinyl alcohol. Two application methods were used to apply PVOH adhesive and alkaline sodium borate cross linker, respectively. PVOH was applied using the glue applicator, as described above and shown in FIGS. 9A and 9B, while alkaline sodium borate cross-linker was applied slot coating into the interior of other ply prior to laminating 2 plies.

### Inventive Example 11

This example is intended to demonstrate that 2-ply product with basis weight of 36.4 lb/3000 ft2 made by separate application of PVOH adhesive and alkaline sodium borate cross-linker at approximately 242 mg/m2 add-on into the interior surfaces of each ply delivered higher wet ply bond and higher wet ply bond/dry ply bond ratio versus Control 2-ply product made with polyvinyl alcohol. Two application methods were used to apply PVOH adhesive and alkaline sodium borate cross linker, respectively. PVOH was applied using the glue applicator, as described above and shown in FIGS. 9A and 9B, while alkaline sodium borate cross-linker was applied slot coating into the interior of other ply prior to laminating 2 plies.

### COMPARATIVE EXAMPLES

### Comparative Example 1

This example demonstrated that polyvinyl alcohol cannot be blended with alkaline sodium borate without a use of cross-linking inhibitor at PVOH to sodium borate by weight ratio 4:1

1 kg quantity of a blend of polyvinyl alcohol with alkaline sodium borate having the composition provided in TABLE 2 was prepared as follows.

500 g 10% active PVOH solution (prepared as described in Inv Ex 1A) was mixed with 331.08 g deionized water at ˜25° C. using an overhead mixer equipped with an impeller. Finally added 168.92 g 7.4% sodium borate solution (prepared as described in Inv Ex 1/Step 2) under stirring at ˜25° C. The final blend was very thick having undesired viscosity and flow properties not suitable for process application (TABLE 2 and FIG. 3)

### Comparative Example 2

This example is intended to demonstrate that polyvinyl alcohol cannot be blended with alkaline sodium borate without a use of cross-linking inhibitor at PVOH to sodium borate by weight ratio of 8:1

1 kg quantity of a blend of polyvinyl alcohol with alkaline sodium borate having the composition provided in TABLE 2 was prepared as follows.

500 g 10% active PVOH solution (prepared as described in Inv Ex 1A) was mixed with 415.54 g deionized water using an overhead mixer equipped with an impeller at ˜25° C. Finally added 84.46 g 7.4% sodium borate solution (prepared as described in Inv Ex 1/Step 2) under stirring at ˜25° C. The final blend was very thick having undesired viscosity and flow properties not suitable for process application (TABLE 2 and FIG. 3)

### Comparative Example 3

This example demonstrated that 5% active polyvinyl alcohol cannot be blended with low pH boric acid at PVOH to boric acid by weight ratio of 4:1

1 kg quantity of a blend of polyvinyl alcohol with alkaline sodium borate having the composition provided in TABLE 2 was by 2 steps.

### Step 1. Preparation of 1 kg 5% Active Boric Acid Solution

5 g of boric acid powder (100% active/Three Elephants, Searles Valley Minerals Inc., Trona, CA) was dissolved in 995 g of deionized water at ˜25° C. using an overhead mixer equipped with an impeller.

Step 2. Blending Polyvinyl Alcohol with Boric Acid Solution

500 g 10% active PVOH solution (prepared as described in Inv Ex 1A) was mixed with 331.08 g deionized water using an overhead mixer equipped with an impeller at ˜25° C. Solution pH was adjusted to approximately pH 5 by addition of approximately 0.2 g of 35% sulfuric acid. Finally added 250 g of 5% boric acid solution under stirring at ˜25° C. There was white gel-like material precipitated out of the solution as soon as boric acid solution was added (FIG. 3).

### Comparative Example 4

This example demonstrated that 5% active polyvinyl alcohol can be blended with low pH boric acid at PVOH to boric acid by weight ratio of 30:1, but the products made using this blend showed inferior wet ply bond values.

1 kg quantity of a blend of polyvinyl alcohol with alkaline sodium borate having the composition provided in TABLE 2 was prepared as follows.

500 g 10% active PVOH solution (prepared as described in Inv Ex 1A) was mixed with 466.7 g deionized water using an overhead mixer equipped with an impeller at ˜25° C. Solution pH was adjusted to approximately pH 5 by addition of approximately 0.2 g of 35% sulfuric acid (VWR). Finally added 33.3 g of 5% boric acid solution (Comp Example 2/Step 1) under stirring at ˜25° C.

The final mixture was clear with no visible solids (FIG. 3).

### Comparative Example 5

This example demonstrated that 2-ply product with basis weight of 36.4 lb/3000 ft2 made using the adhesive disclosed in Comparative Example 4 delivered lowered wet ply bond versus Inventive Example 5 (TABLE 3). A single application method using the glue applicator described above and shown in FIGS. 8A and 8B, was used for the application of the acidic PVOH+boric acid blend.

### Comparative Example 6

This example demonstrated that 1,2-hexanediol is not very efficient as a cross-linking inhibitor at high alkaline sodium borate inclusion levels (P1=4:1; P2=1.2:1) to blend polyvinyl alcohol causing blends with viscosities above the desired ranges.

1 kg quantity of a blend of 5% polyvinyl alcohol with alkaline sodium borate and 1,2-hexanediol mixture (PVOH/sodium borate+1,2-hexanediol ratio=4) having the composition provided in TABLE 2 was prepared as follows.

500 g 10% active PVOH solution (Inv Ex Step 1A) was mixed with 402.34 g deionized water using an overhead mixer equipped with an impeller at ˜25° C. Added 97.66 g 12.8% active sodium borate+1,2-hexanediol mixture (Inv Ex Step 4 Å) under stirring at ˜25° C. to make the final blend having undesired viscosity (TABLE 4) and flow properties at 70° C. (FIG. 3).

### Comparative Example 7

This example demonstrated that as disclosed in U.S. Pat. Nos. 5,693,406, and 5,858,554, thermosetting resins such as polyamidoamine epichlorohydrin (Kymene 5521/Solenis) can be blended with polyvinyl alcohol at low pH formulation and use as a cross-linker without the need for shielding technology. However, it is demonstrated in Comparative Example 7 that polyvinyl alcohol and thermosetting resins blends are not as effective as cross-linkers as alkaline sodium borate and the products laminated with these blends are inferior showing lower wet ply bond (TABLE 3).

A blend of polyvinyl alcohol (71-30 Kuraray; 100% active) and polyamidoamine epichlorohydrin thermosetting resin (Kymene 5221/21% active; Solenis) was used in the procedure disclosed in U.S. Pat. No. 5,858,554. 500 g 10% active PVOH solution (prepared as described in Inv Ex 1/Step 1) was mixed with 440.48 deionized water using an overhead mixer equipped with an impeller at ˜25° C. The pH of the solution was adjusted to pH˜5 by addition on 0.2 g 35% sulfuric acid. 59.52 g 21% active Kymene 5221 solution was added and the final mixture was stirred for 30 minutes at ˜25° C. The final blend had a PVOH/Kymene ratio by weight of 4 at 5% PVOH activity.

### Comparative Example 8

This example demonstrated that 2-ply product with basis weight of 36.4 lb/3000 ft2 made using the adhesive disclosed in Comparative example 7 delivered lowered wet ply bond versus Inventive Example 5 as shown in TABLE 3. A single application method using the glue applicator described above and shown in FIGS. 9A and 9B, was used for the application of the acidic PVOH+PAE resin blend.

In TABLE 3, paper towel products according to the present invention are compared to other commercially available paper towels.

TABLE 3
Ply Bond Data

| | | Wet Ply | Dry Ply | |
|---|---|---|---|---|
| | | Bond | Bond | |
| Product | Company/Plant | (g/inch) | (g/inch) | Wet/dry |
| Bounty | Procter & | 0.7 | 16.6 | 0.04 |
| Control | Gamble | | | |
| WMGVUS GP | Walmart Great | 0.15 | 8.20 | 0.02 |
| | Value Ultra | | | |
| | Strong (Georgia | | | |
| | Pacific) | | | |
| MM Den AN3A | Members Mark | 0.11 | 7.10 | 0.02 |
| | (Sams Club) | | | |
| Kirk Sig Den 43139167 | Kirkland | 0.12 | 2.70 | 0.04 |
| | Signature | | | |
| 23 RP Target | Target | 0.13 | 1.20 | 0.11 |
| Inventive Example 5 | | | | |
| Inventive Example 6 | | | | |
| Inventive Example 7 | | | | |
| Inventive Example 8 | | | | |
| Inventive Example 9 | | 5 | 28.3 | 0.18 |
| Inventive Example 10 | | 7.2 | 27.8 | 0.26 |
| Inventive Example 11 | | 10.6 | 37.7 | 0.28 |
| Comparative Example 5 | | 0.9 | 20.9 | 0.04 |
| Comparative Example 8 | | 2.4 | 16.7 | 0.15 |

TABLE 4
Viscosities of inventive and comparative examples at 70° C.

| | Viscosity (cps) | | |
|---|---|---|---|
| | at 70° C. | Sheer Rate (1/s) | |
| 5% PVOH | 16.5 | 100 | 1/s |
| (71-30; >99% hydrolyzed) | | | |
| Inventive Example 1 | 933 | 1 | 1/s |
| PVOH − SB + Blend | | | |
| (5% PVOH; 1,2-hexanediol; R = 15 | | | |
| Inventive Example 2 | 1126 | 100 | 1/s |
| PVOH − SB + Blend | | | |
| (5% PVOH; glycerol; R = 15 | | | |
| Inventive Example 3 | 12.6 | 100 | 1/s |
| PVOH − SB + Blend | | | |
| (3.5% PVOH; 1,2-hexanediol; R = 15 | | | |
| Inventive Example 4 | 15.7 | 100 | 1/s |
| PVOH − SB + Blend | | | |
| (3.5% PVOH; glycerol; R = 15 | | | |
| Comparative Example 2 | 38,915 | 1 | 1/s |
| PVOH − SB Blend | | | |
| (5% PVOH; R = 8) | | | |
| Comp Example 5 | 6018 | 1 | 1/s |
| PVOH − SB + Blend | | | |
| (3.5% PVOH; 1,2-hexanediol; R = 4 | | | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fibrous structure comprising:
a ply having a first surface and a second surface;
an adhesive composition comprising a borate salt cross-linked polyvinyl alcohol polymer present on the first surface, the cross-linked polymer being a reaction product from the addition of a polyvinyl alcohol, alkaline borate, and cross-linking inhibitor.

2. The fibrous structure of claim 1 wherein the cross-linking inhibitor is a polyol.

3. The fibrous structure of claim 2, wherein the polyol has from 3 to 20 carbon atoms.

4. The fibrous structure of claim 2, wherein the polyol has from 3 to 9 carbon atoms.

5. The fibrous structure of claim 2, wherein the polyol has a weight average molecular weight of less than the polyvinyl alcohol.

6. The fibrous structure of claim 2, wherein the polyol has a weight average molecular weight of less than about 20,000 Daltons.

7. The fibrous structure of claim 2, wherein the polyol is an alkoxylated polyol.

8. The fibrous structure of claim 7, wherein the alkoxylated polyol is at least one of 1,2-hexanediol or 1,3-propanediol.

9. The fibrous structure of claim 1, wherein the weight ratio of polyvinyl alcohol to alkaline borate and cross-linking inhibitor is from about 5:1 to about 30:1.

10. The fibrous structure of claim 1, wherein the weight ratio of polyvinyl alcohol to alkaline borate and cross-linking inhibitor is greater than 10:1.

11. The fibrous structure of claim 1, wherein the weight ratio of alkaline borate to cross-linking inhibitor is from 1:5 to 5:1.

12. The fibrous structure of claim 11, wherein the weight ratio of alkaline borate to cross-linking inhibitor is 1:1.

13. The fibrous structure of claim 1, wherein the adhesive composition has a viscosity up to about 2,000 cps at 1 l/s shear rate and 70° C.

14. The fibrous structure of claim 1, wherein the adhesive composition has a viscosity up to about 1800 cps at 1 l/s shear rate and 70° C.

15. The fibrous structure of claim 1, wherein the adhesive composition has a viscosity up to about 1700 cps at 1 l/s shear rate and 70° C.

16. The fibrous structure of claim 1, wherein the adhesive composition has a viscosity up to about 1500 cps at 1 l/s shear rate and 70° C.

17. The fibrous structure of claim 1, wherein the adhesive composition has a viscosity up to about 1250 cps at 1 l/s shear rate and 70° C.

18. The fibrous structure of claim 1, wherein the adhesive composition has a viscosity from about 15 cps to about 2000 cps at 1 l/s shear rate and 70° C.

19. The fibrous structure of claim 1, wherein the adhesive composition has a viscosity from about 100 cps to about 1800 cps at 1 l/s shear rate and 70° C.

20. The fibrous structure of claim 1, wherein the adhesive composition has a viscosity from about 500 cps to about 1500 cps at 1 l/s shear rate and 70° C.

21. The fibrous structure of claim 1, wherein the adhesive composition has a viscosity from about 700 cps to about 1,000 cps at 1 l/s shear rate and 70° C.

22. The fibrous structure of claim 1, wherein the pH of the alkaline borate is from about 6 to about 10.

23. The fibrous structure of claim 1, comprising a second ply having a first surface and a second surface, wherein the first surface of the second ply is in contact with the second surface of the first ply and the adhesive composition is positioned between the second surface of the first ply and the first surface of the second ply forming a ply bond.

24. The fibrous structure of claim 23, wherein the ply bond is a wet ply bond greater than 1 g/inch.

25. The fibrous structure of claim 24, wherein the wet/dry ply bond ratio is greater than 0.05.

26. The fibrous structure of claim 23, wherein the ply bond is a wet ply bond greater than 1.5 g/inch.

27. The fibrous structure of claim 26, wherein the wet/dry ply bond ratio is greater than 0.1.

28. The fibrous structure of claim 23, wherein the ply bond is a wet ply bond greater than 2.0 g/inch.

29. The fibrous structure of claim 28, wherein the wet/dry ply bond ratio is greater than 0.1.

30. The fibrous structure of claim 1, wherein the adhesive composition comprises at least one of polyethylene oxide, starch, casein, carboxy methyl cellulose, vinyl acetate, vinyl ethylene acetate, vinyl acetate acrylic, polyacrylates, rubber latexes, polyurethane emulsions, polyurethane dispersion, polyvinylidene chloride, styrene-butadiene copolymers, or polychloroprene.

31. The fibrous structure of claim 1, wherein the cross-linking inhibitor less than about 20,000 or less than about 10,000 or less than about 5,000 or less than about 1,000 Daltons.

32. A process for producing a multi-ply fibrous structure comprising:
a. providing a ply having a first surface and a second surface;
b. providing PVOH;
c. providing a mixture of alkaline borate salt and cross-linking inhibitor;
d. adding PVOH to the mixture of alkaline borate and polyol to form an adhesive composition;
e. applying the adhesive composition to the first surface of the absorbent ply.

33. The process of claim 32, wherein a second water absorbent ply having a first surface and a second surface is contacted with the adhesive solution present on the first surface of the water absorbent ply.

34. The process of claim 33, wherein the first surface of the second water absorbent ply is bonded to the first surface of the water absorbent ply through the adhesive solution.

35. The process of claim 32 wherein the mixture sodium borate and cross-linking inhibitor is applied using a slot coater.

36. The of claim 35 wherein the PVOH is applied using a slot coater.
